(19) United States
(12) Patent Application Publication
(10) Pub. No.: US 2026/0310246 A1
(43) Pub. Date: Oct. 8, 2026

(54) PROCESS AND SYSTEM FOR GENERATION OF COKE DRUM OUTAGE PROJECTIONS

(71) Applicant: Chevron U.S.A. Inc., San Ramon, CA (US)

(72) Inventors: Mahdi Khademi, Los Angeles, CA (US); Anshu Anshumali, Mobile, AL (US); Jin Luo, San Ramon, CA (US)

(21) Appl. No.: 19/173,057

(22) Filed: Apr. 8, 2025

(51) Int. Cl. G05D 11/13; C10B 41/00; G05D 9/12

(52) U.S. Cl. CPC G05D 11/13; C10B 41/00; G05D 9/12

(57) ABSTRACT

An apparatus includes at least one processing device configured to obtain sensor data from sensors associated with one or more coke drums in a refinery. The at least one processing device is also configured to generate an outage projection for an end of a feed cycle of at least one of the coke drums by processing, utilizing a machine learning model, information derived from the sensor data characterizing (i) an amount of feedstock which has been fed to the at least one coke drum during the feed cycle, (ii) a time at which a level indicator for the at least one coke drum first exceeds a designated threshold value, and (iii) a density of the feedstock fed to the at least one coke drum during the feed cycle. The at least one processing device is further configured to provide, at a user interface, the generated outage projection.

### BACKGROUND

Refinery systems utilize coking refinery processes to convert feedstock into petroleum coke, also referred to simply as coke. Coking refinery processes include delayed coking and fluid coking. In delayed coking, multiple vessels referred to as coke drums are utilized, where a first set of the coke drums are filled with feedstock while a second set of the coke drums are unloaded, to enable continuous production. The transition between filling and unloading a particular coke drum is triggered through estimating an outage level of the coke drum. The outage level of the coke drum, which is a measurement of an amount of space between a top of the coke drum and a level of coke within the coke drum, cannot be directly measured. Currently, human operators rely primarily on experience to manually estimate the outage levels of coke drums, which is subject to error. Techniques are need for automatically estimating the outage levels of coke drums which do not rely on the expertise of human operators.

### SUMMARY

In accordance with an illustrative embodiment, an apparatus comprises at least one processing device comprising a processor coupled to a memory, the at least one processing device being configured:
to obtain sensor data from one or more sensors associated with one or more coke drums in a refinery implementing a delayed coking process for converting at least a portion of a feedstock to a product stream comprising coke,
to generate an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle, and
to provide, at a user interface, the generated outage projection for the end of the feed cycle of said at least one of the one or more coke drums.

In accordance with another illustrative embodiment, a method performed by at least one processing device comprising a processor coupled to a memory comprises:
obtaining sensor data from one or more sensors associated with one or more coke drums in a refinery implementing a delayed coking process for converting at least a portion of a feedstock to a product stream comprising coke,
generating an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle, and
providing, at a user interface, the generated outage projection for the end of the feed cycle of said at least one of the one or more coke drums.

In accordance with another illustrative embodiment, a computer program product comprises a non-transitory processor-readable storage medium having stored therein program code of one or more software programs, where the program code when executed by at least one processing device causes the at least one processing device:
to obtain sensor data from one or more sensors associated with one or more coke drums in a refinery implementing a delayed coking process for converting at least a portion of a feedstock to a product stream comprising coke,
to generate an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle, and
to provide, at a user interface, the generated outage projection for the end of the feed cycle of said at least one of the one or more coke drums.

### BRIEF DESCRIPTION OF THE DRAWINGS

In combination with the accompanying drawing and with reference to the following detailed description, the features, advantages, and other aspects of the implementations of the present disclosure will become more apparent, and several implementations of the present disclosure are illustrated herein by way of example but not limitation. In the accompanying drawings:

FIG. 1 illustrates a schematic diagram of a system configured for management of a refinery that performs delayed coking refinery processes, according to an illustrative embodiment.

FIG. 2A illustrates a schematic diagram of a process and system for converting one or more feedstocks comprising Petroleum Resid or one or more feedstocks comprising a solid carbon-based material to a product stream comprising a gas phase comprising hydrocarbons and hydrogen, and coke utilizing an unheated coke drum, according to an illustrative embodiment.

FIG. 2B illustrates a schematic diagram of a process and system for converting one or more feedstocks comprising Petroleum Resid or one or more feedstocks comprising a solid carbon-based material to a product stream comprising a gas phase comprising hydrocarbons and hydrogen, and coke utilizing an unheated coke drum, according to an illustrative embodiment.

FIG. 3 illustrates a schematic diagram of sensor arrangement for a coke drum utilized in a delayed coking refinery process, according to an illustrative embodiment.

FIG. 4 illustrates a schematic diagram of actual and target levels of coke within a coke drum utilized in a delayed coking refinery process, according to an illustrative embodiment.

FIG. 5 illustrates a process for generating of a coke drum outage prediction model for coke drums utilized in delayed coking refinery processes, and for generating a dashboard interface for outputting coke drum outage predictions obtained utilizing the coke drum outage prediction model, according to an illustrative embodiment.

FIG. 6 illustrates a process for training coke drum outage prediction models for coke drums utilized in delayed coking refinery processes, according to an illustrative embodiment.

FIG. 7A illustrates a view of a dashboard interface for outputting simplified coke drum outage prediction information obtained from a coke drum outage prediction model for coke drums utilized in delayed coking refinery processes, according to an illustrative embodiment.

FIG. 7B illustrates a view of a dashboard interface for outputting advanced coke drum outage prediction information obtained from a coke drum outage prediction model for coke drums utilized in delayed coking refinery processes, according to an illustrative embodiment.

FIG. 7C illustrates a view of a dashboard interface for outputting outage history information for coke drums utilized in delayed coking refinery processes, according to an illustrative embodiment.

FIG. 8 illustrates a process for generating coke drum outage projections, according to an illustrative embodiment.

FIG. 9 illustrates an information processing system that may be utilized to implement at least a portion of a refinery management system, according to an illustrative embodiment.

### DETAILED DESCRIPTION

Various illustrative embodiments described herein are directed to processes and systems for management of coking refinery processes in refinery systems, including delayed coking refinery processes utilizing one or more coke drums.

Delayed coking is a semi-batch process that feeds heavy hydrocarbons including, for example, hydrocarbons with high molecular weight and high boiling points. The coking process generally includes isolating coke drums from the atmosphere, removing air/oxygen with steam or other methods, preheating coke drums using steam and hydrocarbon vapor, and then feeding the heated coke drums. After the feeding and thermal cracking cycle ends, the coke drums are stripped with vapors, including steam, cooled by means of steam and water to minimize volatile hydrocarbons in the vapor space, and then opened to the atmosphere for drilling and cutting, as well as releasing coke to the storage pit for dewatering and transportation.

As mentioned above, management of feed cycles of coke drums in a refinery is a complex task which in conventional approaches relies on human operators to estimate the level of coke within coke drums, as direct measurement of the level of coke is not practical without having to open the coke drum for unloading. Transitioning coke drums between filling and unloading operations is triggered through estimating the outage level of the coke drums.

The illustrative embodiments described herein overcome these and other drawbacks by providing processes and systems for generation of coke drum outage projections during feed cycles thereof.

### Definitions

As used in this disclosure the word “comprises” or “comprising” is intended as an open-ended transition meaning the inclusion of the named elements, but not necessarily excluding other unnamed elements. The phrase “consists essentially of” or “consisting essentially of”′ is intended to mean the exclusion of other elements of any essential significance to the composition. The phrase “consisting of” or “consists of” is intended as a transition meaning the exclusion of all but the recited elements with the exception of only minor traces of impurities.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

The term “crude oil” as used herein refers to petroleum extracted from geologic formations in its unrefined form. Crude oil suitable as the source material for the processes herein include Arabian Heavy, Arabian Light, Arabian Extra Light, other Persian Gulf crudes, Brent, North Sea crudes, North and West African crudes, Indonesian, Chinese crudes, or mixtures thereof. The crude petroleum mixtures can be whole range crude oil or topped crude oil. As used herein, “crude oil” also refers to such mixtures that have undergone some pre-treatment such as water-oil separation; and/or gas-oil separation; and/or desalting; and/or stabilization. In certain embodiments, crude oil refers to any of such mixtures having an API gravity (ASTM D287 standard), of greater than or equal to about 20°, 30°, 32°, 34°, 36°, 38°, 40°, 42° or 44°.

The term “Petroleum Resid” as used as used herein refers to regular coker feed, including mainly but not limited to heavy hydrocarbon from the bottom of the crude units and any other typical coker feed like slurry, bunker fuel, Asphalt and Tar and mixture of.

The term “municipal solid waste” as used herein refers to nonliquid waste that comes from homes, institutions, and small businesses.

The term “upgrade” or “upgrading” generally means to improve quality and/or properties of a stream and is meant to include physical and/or chemical changes to a stream. Further, upgrading is intended to encompass removing impurities (e.g., heteroatoms, metals, etc.) from, for example, a hydrocarbon stream, converting a portion of the hydrocarbons into shorter chain length hydrocarbons, cleaving single ring or multi-ring aromatic compounds present in a hydrocarbon stream, and/or reducing viscosity of a hydrocarbon stream or converting to higher value products.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

Although any processes and materials similar or equivalent to those described herein can be used in the practice or testing of the illustrative embodiments described herein, the typical processes and materials are herein described.

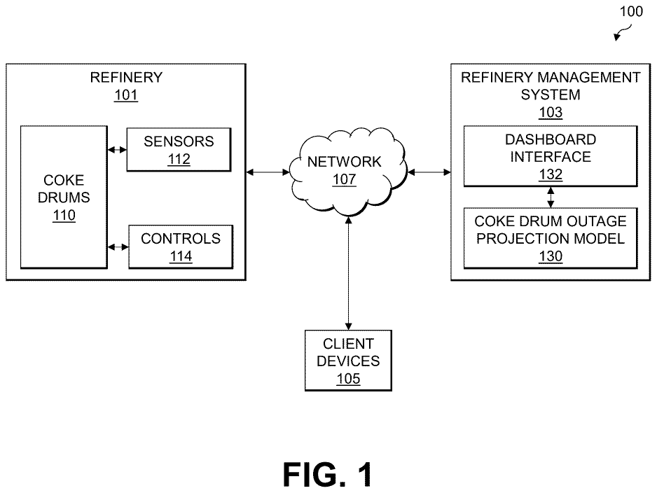

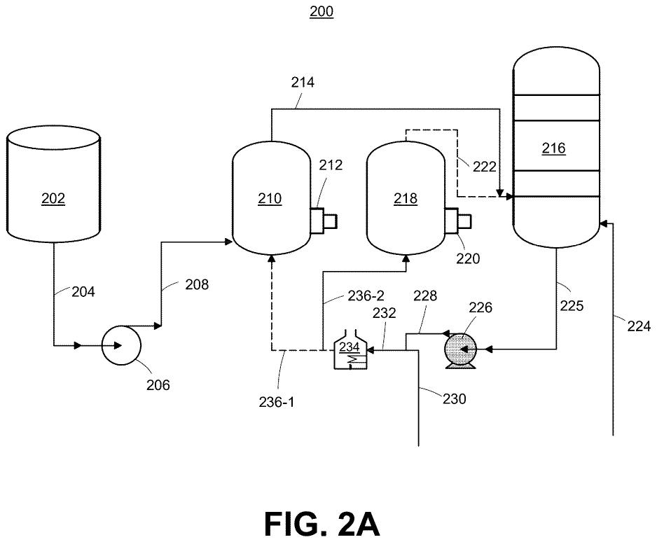

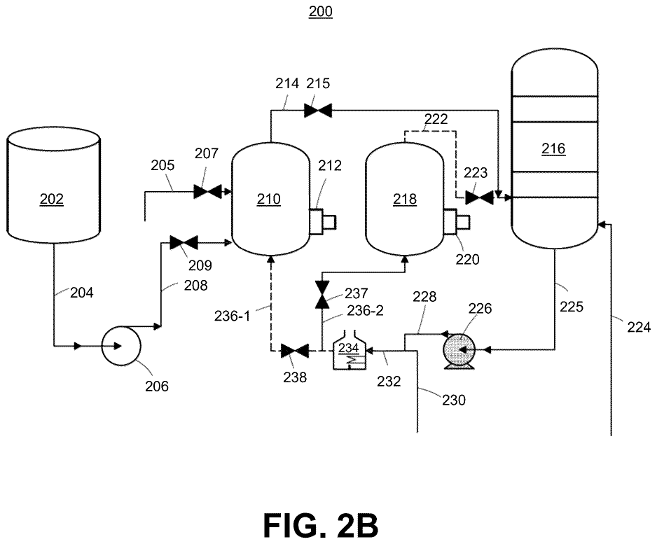

The illustrative embodiments of the present disclosure will be specifically described below with reference to the accompanying drawings. For the purpose of clarity, some aspects of a refinery (e.g., as illustrated in FIG. 1) and steps leading up to the conversion of one or more solid carbon-based feedstocks in a refinery (e.g., as illustrated in FIGS. 2A and 2B) are omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

Referring now to the drawings in more detail, FIG. 1 shows information processing system 100 configured in accordance with an illustrative embodiment. Information processing system 100 is assumed to be built on at least one processing platform and provides functionality for generation of coke drum outage projections during feed cycles thereof. Information processing system 100 includes refinery 101, refinery management system 103 and client devices 105 which are coupled to network 107. Refinery 101 is configured to convert one or more feedstocks utilizing a delay coking process utilizing coke drums 110. Coke drums 110 are associated with sensors 112 (e.g., temperature sensors, pressure sensors, level sensors such as nuclear backscatter sensors, X-ray sensors, Gamma-ray sensors, point intensity measurement sensors, etc.) and controls 114 (e.g., valves, actuators, etc.). Refinery management system 103 implements coke drum outage projection model 130 configured to generate predictions or estimates of outage levels of coke drums 110 during feed cycles, and for utilizing such predictions in generating outputs of dashboard interface 132 (e.g., a graphical user interface (GUI) output on a display of refinery management system 103 or accessible over network 107 by client devices 105). To do so, refinery management system 103 may obtain data from sensors 112 associated with coke drums 110 of refinery 101. Refinery management system 103 may comprise or be implemented utilizing physical and/or virtual computing resources in an information technology (IT) infrastructure. Physical computing resources may include physical hardware such as servers, storage systems, networking equipment, Internet of Things (IOT) devices, other types of processing and computing devices including desktops, laptops, tablets, smartphones, etc. Virtual computing resources may include virtual machines (VMs), containers, etc.

In some embodiments, refinery management system 103 is used by an operator of refinery 101, where the operator subscribes to or otherwise utilizes refinery management system 103 for generating outage predictions for coke drums 110 of refinery 101, and for adjusting controls 114 to dynamically adjust aspects of a delayed coking process (e.g., amounts of residual fed to coke drums 110) in order to meet target outage levels for feed cycles of coke drums 110.

Client devices 105 may comprise, for example, physical computing devices such as IoT devices, mobile telephones, laptop computers, tablet computers, desktop computers or other types of devices utilized by members of an entity that operates refinery 101 (e.g., to obtain outage predictions for coke drums 110, to determine appropriate sets of values for controls 114 or adjustments thereof during feed cycles of coke drums 110 to meet target outage levels, etc.). Such devices are examples of what are more generally referred to herein as “processing devices.” Some of these processing devices are also generally referred to herein as “computers.” Client devices 105 may also or alternately comprise virtualized computing resources, such as VMs, containers, etc. Client devices 105 in some embodiments comprise respective computers associated with a particular company, organization or other enterprise which operates refinery 101. Thus, client devices 105 may be considered examples of assets of the enterprise which operates refinery 101. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

Network 107 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

Although not explicitly shown in FIG. 1, one or more input-output devices such as keyboards, displays or other types of input-output devices may be used to support one or more user interfaces to the refinery management system 103, as well as to support communication between the refinery management system 103 and other related systems and devices not explicitly shown.

Refinery management system 103 may be provided as a cloud service that is accessible by client devices 105 to allow users thereof to determine predictions of outage levels for coke drums 110 of refinery 101, and for determining sets of values for controls 114 or adjustments thereto during feed cycles of coke drums 110 of refinery 101 to meet a designated target outage level. In some embodiments, client devices 105 are utilized by members of the same enterprise, organization or other entity that operates refinery 101. In other embodiments, client devices 105 are utilized by members of one or more enterprises, organizations or other entities different than the enterprise, organization or other entity that operates refinery 101 (e.g., a first enterprise provides support functionality for multiple different refineries including refinery 101). Various other examples are possible.

In some embodiments, refinery 101 and refinery management system 103 may implement agents that are configured for automated transmission of information and commands with one another (e.g., transmitting sensor data from sensors 112 and control information from controls 114 to refinery management system 103, transmitting commands for actuating or adjusting controls 114 from refinery management system 103 to refinery 101, etc.). It should be noted that an “agent” as this term is generally used herein may comprise an automated entity, such as a software entity running on a processing device. Accordingly, an agent need not be a human entity.

Refinery 101 and refinery management system 103 in the FIG. 1 embodiment are assumed to be implemented using at least one processing platform comprising one or more processing devices each having a processor coupled to a memory. Such processing devices can illustratively include particular arrangements of compute, storage and network resources (e.g., at least one processor and an associated memory) that implements one or more functional modules or logic for controlling certain features of the refinery 101 and/or refinery management system 103. For example, sensors 112 of refinery 101 may be implemented using at least one processing device that is provisioned with logic providing functionality for obtaining raw sensor data from coke drums 110 or other components of refinery 101, for potentially processing the raw sensor data and transmitting the raw or processed sensor data to refinery management system 103. Controls 114 of refinery 101 may be implemented utilizing at least one processing device that is provisioned with logic providing functionality for controlling elements of refinery 101 (e.g., valves, actuators, heating elements, pumps, etc.). Such control may be based on instructions or commands received from refinery management system 103 based on outage predictions generated utilizing coke drum outage projection model 130. Coke drum outage projection model 130 may be implemented using at least one processing device that is provisioned with logic for training one or more artificial intelligence and machine learning models to generate predictions of outage levels for coke drums 110 of refinery 101, to generate sets of values for controls 114 of refinery 101 such that coke drums 110 achieve a designated target outage level during feed cycles, etc. Dashboard interface 132 may be implemented using at least one processing device that is configured to drive a display or otherwise produce a GUI (e.g., accessible by client devices 105 via network 107) to display information (e.g., outage predictions for coke drums 110 of refinery 101, recommended sets of values for controls 114 of refinery 101 that will meet designated target outage levels in coke drums 110 of refinery 101 during feed cycles thereof, etc.). At least portions of such logic may be implemented at least in part in the form of software that is stored in memory and executed by a processor.

It is to be appreciated that the particular arrangement of refinery 101, refinery management system 103, client devices 105 and network 107 illustrated in the FIG. 1 embodiment is presented by way of example only, and alternative arrangements can be used in other embodiments. For example, refinery management system 103, or portions or components thereof, may in some embodiments be implemented internal to refinery 101 rather than as a separate, external element. Further, refinery management system 103 and other portions of information processing system 100, as will be described in further detail below, may be part of cloud infrastructure.

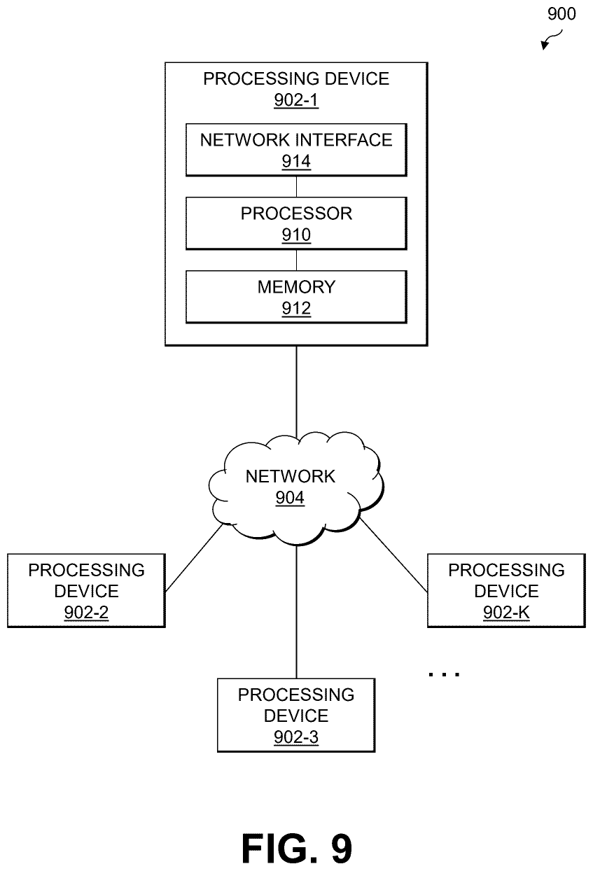

The term “processing platform” as used herein is intended to be broadly construed so as to encompass, by way of illustration and without limitation, multiple sets of processing devices and associated storage systems that are configured to communicate over one or more networks. For example, distributed implementations of information processing system 100 are possible, in which certain components of the system reside in one data center in a first geographic location while other components of the system reside in one or more other data centers in one or more other geographic locations that are potentially remote from the first geographic location. Thus, it is possible in some implementations of information processing system 100 for one or more portions or components thereof to reside in different data centers, or for one or more portions or components thereof to be implemented in a distributed manner across multiple data centers. Additional examples of processing platforms utilized to implement information processing system 100 in illustrative embodiments will be described in more detail below in conjunction with FIG. 9.

It is to be understood that the particular set of elements shown in FIG. 1 for generation of coke drum outage projections is presented by way of illustrative example only, and in other embodiments additional or alternative elements may be used. Thus, another embodiment may include additional or alternative systems, devices and other network entities, as well as different arrangements of modules and other components. It is to be appreciated that these and other features of illustrative embodiments are presented by way of example only, and should not be construed as limiting in any way.

FIGS. 2A and 2B illustrate a process and system including a storage unit, a first coke drum, a second coke drum and a fractionator for separating a product stream including gases and hydrocarbons from the coke drums and for recovering one or more liquid distillate products and heavy bottoms. As will be appreciated by one of skill in the art, the components of the system can be in fluid communication with each other through any suitable conduits (e.g., pipes, streams, etc.). It is to be understood that the process and system including at least the storage unit, the first coke drum, the second coke drum and the fractionator is not limited to the configuration of the embodiments shown in FIGS. 2A and 2B, and other configurations are contemplated herein. In addition, while the exemplary embodiments are described in FIGS. 2A and 2B with a process and system having a first coke drum and a second coke drum, it is to be appreciated that any number of coke drums arranged in any series or parallel are contemplated herein. For ease of understanding, specific examples mentioned in the following description are all illustrative and are not used to limit the protection scope of the present disclosure.

FIGS. 2A and 2B show a system 200 including a storage unit 202 for storing the one or more feedstocks comprising crude oil or one or more feedstocks comprising a solid carbon-based material. Storage unit 202 can be any conventional storage unit for storing the one or more feedstocks comprising a solid carbon-based material. For example, storage unit 202 can be a silo designed for efficient discharge of the one or more feedstocks comprising crude oil or the one or more feedstocks comprising a solid carbon-based material.

Suitable feedstocks comprising a solid carbon-based material include, for example, feedstocks having a carbon content of at least about 75 weight percent. In some embodiments, feedstocks comprising a solid carbon-based material can have a carbon content of about 75 weight percent to about 99 weight percent. In some embodiments, feedstocks comprising a solid carbon-based material can have a carbon content of about 80 weight percent to about 99 weight percent. In some embodiments, feedstocks comprising a solid carbon-based material can have a carbon content of about 90 weight percent to about 98 weight percent.

In an illustrative embodiment, the form of the one or more feedstocks comprising a solid carbon-based material can include any of the forms of articles, products, materials, or portions thereof. For example, a portion of an article, product, material, or portions thereof can take the form of sheets, extruded shapes, moldings, films, carpet, laminates, foam pieces, chips, flakes, particles, agglomerates, briquettes, elastomers, powders, shredded pieces, long strips, randomly shaped pieces having a wide variety of shapes, or any other form other than the original form of the article and adapted to feed to the one or more coke drums discussed hereinbelow.

In an illustrative embodiment, as may be combined with one or more of the preceding paragraphs, the one or more feedstocks comprising a solid carbon-based material can be in the form of solid particles, such as chips, flakes, or a powder. In another embodiment, the one or more feedstocks comprising a solid carbon-based material may comprise particulates such as, for example, shredded plastic particles, chopped plastic particles, or plastic pellets.

In an illustrative embodiment, as may be combined with one or more of the preceding paragraphs, the one or more feedstocks comprising a solid carbon-based material can be derived from sustainable renewables resources such as, for example, plants or algae.

In some embodiments, suitable one or more feedstocks comprising a solid carbon-based material include, for example, polymers, biomass and the like.

A polymer is a carbon-based (at least 50 mass % C) material chiefly made up of repeating units and having a number average molecular weight of at least about 100, or greater than about 1000 or greater than about 10,000. Suitable polymers include, for example, thermoplastic polymers such as, for example, polyethylene, polypropylene, polyesters, polyethylene terephthalate (PET), acrylonitrile-butadiene-styrene (ABS) copolymers, polyamide, polyurethane, polyethers, polycarbonates, poly(oxides), poly(sulfides), polyarylates, polyetherketones, polyetherimides, polysulfones, polyurethanes, polyvinyl alcohols, and polymers produced by polymerization of monomers, such as, for example, dienes, olefins, styrenes, acrylates, acrylonitrile, methacrylates, methacrylonitrile, diacids and diols, lactones, diacids and diamines, lactams, vinyl halides, vinyl esters, block copolymers thereof, and alloys thereof, thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer; and blends thereof.

In some embodiments, suitable polymers for one or more solid carbon-based feedstocks include, for example, one or more polyesters, one or more polyolefins (PO), and/or polyvinyl chloride (PVC). Representative examples of suitable polymers for one or more solid carbon-based feedstocks include one or more of elected from the group consisting of a polyethylene (PE), a polypropylene (PP), a polyethylene terephthalate (PET), a polyvinyl chloride (PVC), a polystyrene (PS), an aromatic polymer such as polysulfone, polycarbonate (PC), polyphenylene sulfide (PPS), polyimides polysulfone (PSU) and mixtures thereof.

Suitable biomass for the one or more feedstocks comprising a solid carbon-based material includes, for example, plant and plant-derived material, vegetation, agricultural waste, forestry waste, wood waste, paper waste, animal-derived waste, poultry-derived waste, municipal solid waste, cellulose, carbohydrates or derivates thereof, charcoal, and the like, and combinations/mixtures thereof.

Representative examples of biomass that can additionally or alternately be present as solid carbon-based feedstock components can include, but are not limited to, timber harvesting residues, softwood chips, hardwood chips, tree branches, tree stumps, leaves, bark, sawdust, off-spec paper pulp, corn, corn cob, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, plastic, cloth, and the like, and combinations/mixtures thereof.

In an illustrative embodiment, as may be combined with one or more of the preceding paragraphs, the one or more feedstocks comprising a solid carbon-based material can be washed to remove any metal contaminants either before entering storage unit 202 or after exiting storage unit 202. Representative examples of metal contaminants include sodium, calcium, magnesium, aluminum, and non-metal contaminants coming from other waste sources. Non-metal contaminants include contaminants coming from the Periodic Table Group 14, such as silica, contaminants from Group 15, such as phosphorus and nitrogen compounds, contaminants from Group 16, such as sulfur compounds, and halide contaminants from Group 17, such as fluoride, chloride, and iodide. The residual metals, non-metal contaminants, and halides may be removed to less than about 50 parts per million (ppm), or less than about 30 ppm or less than about 5 ppm if required by equipment design and metallurgy.

Turning back to FIGS. 2A and 2B, system 200 further includes transfer device 206 for receiving the one or more feedstocks comprising crude oil or a solid carbon-based material via line 204. In some embodiments, transfer device 206 can be a bucket elevator, a solid conveyer, or a pneumatic transportation system for sending the one or more feedstocks comprising crude oil or the one or more feedstocks comprising a solid carbon-based material such as in a solid form to coke drum 210 via line 208. In some embodiments, transfer device 206 can be any suitable pump for increasing the pressure of the one or more feedstocks comprising crude oil or the one or more feedstocks comprising a solid carbon-based material such as in a slurry form for sending the one or more feedstocks comprising crude oil or the one or more feedstocks comprising a solid carbon-based material to coke drum 210 via line 208. For example, transfer device 206 may be a centrifugal pump, a rotary pump including an impeller, or alternatively may be any other suitable fluid pump. In some embodiments, transfer device 206 is a large recirculation pump.

System 200 further includes valve 209 for allowing the one or more feedstocks comprising crude oil or the one or more feedstocks comprising a solid carbon-based material to enter coke drum 210 via line 208 (See FIG. 2B).

In system 200, coke drum 210 is configured for receiving a purge stream via line 205 using valve 207, and for receiving the one or more feedstocks comprising crude oil or the one or more feedstocks comprising a solid carbon-based material via line 208 using valve 209 (See FIG. 2B). In some embodiments, purge stream can include, for example, steam, light hydrocarbon gases, hydrogen, nitrogen and carbon dioxide. Coke drum 210 can be any conventional coke drum design used in refinery processing units. Coke drum 210 further includes heating element 212 for heating the one or more feedstocks comprising crude oil or the one or more solid carbon-based feedstocks in coke drum 210. In some embodiments, heating element 212 is external to coke drum 210. In some embodiments, heating element 212 is internal to coke drum 210. Although heating element 212 is shown as a single heating element, this is merely illustrative and any number of external and/or internal heating elements are contemplated for use in system 200.

Heating element 212 is a dedicated heating element to heat the one or more feedstocks comprising a solid carbon-based material in coke drum 210. Heating element 212 can be any conventional heating unit known in the art. In some embodiments, heating element 212 can provide heat to coke drum 210 using, for example, electric heating, microwave heating, ultrasonic heating, induction heating, direct electric energy or sources or electromagnetic sources. In some embodiments, heating element 212 can be a super gas or vapor heater such as a steam heater, and may include a heating element, such as a resistive or inductive heating element. In some embodiments, heating element 212 can be an air heater, which may include a resistive or inductive heating element configured to heat air, carbon dioxide or inert gas.

In some embodiments, heating element 212 includes or utilizes electromagnetic radiation. In an embodiment, electromagnetic radiation comprises UV light, near ultraviolet light, near infrared light, infrared light, visible light, laser, electron beam, or combinations thereof.

In some embodiments, heating element 212 includes a furnace heater. For example, a furnace heater can heat the one or more feedstocks comprising a solid carbon-based material in coke drum 210 using an exhaust heated by a burner that combusts a portion of, for example, a fuel gas stream such as natural gas or gasoline.

In non-limiting illustrative embodiments, the one or more feedstocks comprising crude oil or the one or more feedstocks comprising a solid carbon-based material enter coke drum 210 via line 208 while coke drum 210 is in a heated state or in an unheated state (i.e., coke drum 210 is at room temperature), and heating element 212 heats the one or more feedstocks comprising crude oil or the one or more feedstocks comprising a solid carbon-based material. In some embodiments, heating element 212 heats the one or more feedstocks comprising a solid carbon-based material to a first temperature sufficient to convert the heated one or more feedstocks comprising a solid carbon-based material to one of a semi-solid state, flowing fluid or melted state.

In some embodiments, heating element 212 can heat the one or more feedstocks comprising crude oil or the one or more feedstocks comprising a solid carbon-based material to a temperature ranging from about 160° C. to about 320° C. For example, depending on the particular feedstock comprising a solid carbon-based material such as a plastic feed source and the process configuration, the first temperature for heating coke drum 210 can be a narrower range such as from about 160° C. to about 260° C. (about 320° F. to about 500° F.) or about 260° C. to about 320° C. (about 500° F. to about 608° F.).

As one skilled in the art will readily appreciate, when the one or more feedstocks comprising a solid carbon-based material is a single feedstock, the melting point is of that particular feedstock. In the case where the one or more feedstocks comprising a solid carbon-based material are more than one feedstock, then the melting point of the one or more feedstocks comprising a solid carbon-based material will be the melting point of the feedstock or flowing status comprising a solid carbon-based material with the highest melting point or flowing capability. Thus, the melting points of all the feedstocks comprising a solid carbon-based material must be exceeded.

Although it is shown that the one or more feedstocks comprising crude oil or the one or more feedstocks comprising a solid carbon-based material enter coke drum 210 via line 208, it is contemplated that the one or more feedstocks comprising crude oil or the one or more feedstocks comprising a solid carbon-based material can enter coke drum 210 at more than one inlet and at any position of coke drum 210. For example, the one or more feedstocks comprising crude oil or the one or more feedstocks comprising a solid carbon-based material can enter coke drum 210 at one or more of a bottom inlet, a middle inlet and a top inlet of coke drum 210.

In some embodiments, following heating the one or more feedstocks comprising a solid carbon-based material to a temperature sufficient to convert the heated one or more feedstocks comprising a solid carbon-based material to one of a semi-solid state or melted state, coke drum 210 further receives a heated petroleum residue-containing feedstock via line 236-1. As will be discussed below, the petroleum residue-containing feedstock can include a petroleum residue stream, as well as a heavy bottoms from fractionator 216. In some embodiments, a petroleum residue stream can include, for example, heavy bottoms from processing of crude oil in a crude unit, a heavy cycle oil of a fluid catalytic cracking unit, tar, etc. In some embodiments, a petroleum residue stream can include, for example, residue from an atmospheric distillation column, residue from a vacuum distillation column, residue from a visbreaker, fuel oil, pitch from solvent deasphalting, or any combination of these. As used herein, the term “heavy” means having a higher boiling point and the term “light” means having a lower boiling point.

When entering coke drum 210, the heated petroleum residue-containing feedstock will be a temperature ranging from about 450° C. to about 650° C. Thus, this temperature may be sufficient such that the heated one or more feedstocks comprising a solid carbon-based material in one of a semi-solid state or a melted state and the heated petroleum residue-containing feedstock can undergo one or more reactions such as, for example, pyrolysis, thermal cracking, decomposition, and annealing to convert the heated one or more feedstocks comprising a solid carbon-based material in one of a semi-solid or melted state to a product stream comprising a gas phase comprising hydrocarbons and hydrogen, and coke. If necessary, heating element 212 can be used to further add additional heat to coke drum 210 to assist in the one or more reactions.

In some embodiments, the one or more feedstocks comprising crude oil or the one or more feedstocks comprising a solid carbon-based material first enter coke drum 210 until a sufficient amount is present in coke drum 210. In non-limiting illustrative embodiments, a sufficient amount includes, for example, the one or more feedstocks comprising crude oil or the one or more feedstocks comprising a solid carbon-based material filling from about 10% to about 50%, or from 10% to about 30% of coke drum 210. Once a sufficient amount of the one or more feedstocks comprising crude oil or the one or more feedstocks comprising a solid carbon-based material is reached in coke drum 210, the one or more feedstocks comprising crude oil or the one or more feedstocks comprising a solid carbon-based material are then heated by heating element 212 until, for example, the heated one or more feedstocks comprising a solid carbon-based material are in one of a semi-solid state or melted state. Next, the heated petroleum residue-containing feedstock enters coke drum 210 to assist in converting the one or more feedstocks comprising crude oil or the one or more feedstocks comprising a solid carbon-based material to a product stream comprising a gas phase comprising hydrocarbons and hydrogen and coke.

In some embodiments, if any oxygen is present in coke drum 210 prior to heating coke drum 210, a typical air freeing operation can be performed including the use of steam or an inert gas such as nitrogen or carbon dioxide.

In a non-limiting illustrative embodiment, the heated one or more feedstocks comprising crude oil or the heated one or more feedstocks comprising a solid carbon-based material in one of a semi-solid state or a melted state and the heated petroleum residue-containing feedstock are pyrolyzed in coke drum 210. The pyrolysis reaction involves chemical and thermal decomposition of the heated one or more feedstocks comprising crude oil or the heated one or more feedstocks comprising a solid carbon-based material in one of a semi-solid state or a melted state and the heated petroleum residue-containing feedstock. Although pyrolysis processes may be generally characterized by a reaction environment that is substantially free of oxygen, pyrolysis processes may be further defined, for example, by the pyrolysis reaction temperature within the reactor, the residence time in the pyrolysis reactor, the pressure within the pyrolysis reactor, and the presence or absence of pyrolysis catalysts.

In some embodiments, the pyrolysis reaction can involve heating and converting the heated one or more feedstocks comprising crude oil or the heated one or more feedstocks comprising a solid carbon-based material in one of a semi-solid state or a melted state and the heated petroleum residue-containing feedstock under an anaerobic atmosphere. An anaerobic atmosphere may be a non-oxidizing atmosphere without oxygen in or is substantially free of oxygen or in an atmosphere that contains less oxygen relative to ambient air. For example, the atmosphere within coke drum 210 may include not more than 5 wt. %, not more than 4 wt. %, not more than 3 wt. %, not more than 2 wt. %, not more than 1 wt. %, or not more than 0.5 wt. % of oxygen.

In some embodiments, additives such as, for example, silicon, iron and molybdenum can be added via line 208 in order to affect the morphology of the coke formed.

The temperature in coke drum 210 to pyrolyze the heated one or more feedstocks comprising crude oil or the heated one or more feedstocks comprising a solid carbon-based material in one of a semi-solid state or a melted state and the heated petroleum residue-containing feedstock can be adjusted to facilitate the production of certain end products. In some embodiments, a suitable temperature includes, for example, at least about 325° C., or at least about 350° C., or at least about 375° C., or at least about 400° C. In some embodiments, a suitable temperature includes, for example, a temperature of not more than about 800° C., or not more than about 700° C., or not more than about 650° C., or not more than about 600° C., or not more than about 550° C., or not more than about 525° C., or not more than about 500° C. In some embodiments, a suitable temperature includes, for example, a temperature of from about 325° C. to about 800° C., or about 350° C. to about 600° C., or about 375° C. to about 500° C., or about 400° C. to about 500° C.

In some embodiments, the reaction conditions can include, for example, a suitable residence time of the heated one or more feedstocks comprising crude oil or the heated one or more feedstocks comprising a solid carbon-based material in one of a semi-solid state or a melted state and the heated petroleum residue-containing feedstock within coke drum 210 can be at least about 10 hours, or from about 10 hours to about 48 hours, or from about 12 hours to about 24 hours. In some embodiments, the reaction conditions can include, for example, maintaining coke drum 210 at a pressure of at least about 1 atmosphere, or from about 1 atmosphere to about 10 atmospheres. In some embodiments, coke drum 210 can be maintained at a pressure of less than about 1 atmosphere or under vacuum. Any combination of the foregoing ranges with the residence time and the pressure are contemplated including combinations of the residence time with the pressure.

In some embodiments, the pyrolysis reaction in coke drum 210 can be a thermal pyrolysis, which is carried out in the absence of a catalyst, or a catalytic pyrolysis, which is carried out in the presence of a catalyst. When a catalyst is used, the catalyst can be homogenous or heterogeneous and may include, for example, certain types of zeolites and other mesostructured catalysts.

In some embodiments, the pyrolysis reaction results in a product stream comprising a gas phase comprising hydrocarbons and hydrogen, and coke. In some embodiments, the product stream exits coke drum 210 via line 214 and is sent to fractionator 216 as discussed below, and coke remains in coke drum 210 (see FIG. 2A). In some embodiments, the product stream exits coke drum 210 via line 214 and is combined with a product stream via line 222 from coke drum 218 as discussed below and sent to fractionator 216 (see FIG. 2A). In some embodiments, the product stream exits coke drum 210 via line 214 using valve 215 and is sent to fractionator 216 as discussed below, and coke remains in coke drum 210 (see FIG. 2B) for further processing. In some embodiments, the product stream exits coke drum 210 via line 214 using valve 215 and is combined with another product stream via line 222 using valve 223 from coke drum 218 as discussed below and sent to fractionator 216 (see FIG. 2B).

In a non-limiting illustrative embodiment, thermal cracking of the heated one or more feedstocks comprising crude oil or the heated one or more feedstocks comprising a solid carbon-based material in one of a semi-solid state or a melted state and the heated petroleum residue-containing feedstock is carried out in coke drum 210. In some embodiments, the thermal cracking operation is carried out in the presence of steam under an anaerobic atmosphere as discussed above. In some embodiments, the thermal cracking operation in coke drum 210 can be carried out in the absence of a catalyst.

Suitable thermal cracking conditions include, for example, a reaction temperature of about 450° C. to about 600° C., or about 500° C. to about 550° C., a suitable residence time of the solid carbon-based feedstock within coke drum 210 can be at least about 10 hours, or from about 12 hours to about 48 hours, and a pressure ranging from about 1 atm to about 10 atm, or from about 1 atm to about 5 atm, or from about 5 atm to about 10 atm.

In some embodiments, the thermal cracking operation results in a product stream comprising a gas phase comprising hydrocarbons and hydrogen, and coke.

In some embodiments, the product stream exits coke drum 210 via line 214 and is sent to fractionator 216 as discussed below, and coke remains in coke drum 210 (see FIG. 2A). In some embodiments, the product stream exits coke drum 210 via line 214 and is combined with a product stream via line 222 from coke drum 218 as discussed below and sent to fractionator 216 (see FIG. 2A). In some embodiments, the product stream exits coke drum 210 via line 214 using valve 215 and is sent to fractionator 216 as discussed below, and coke remains in coke drum 210 (see FIG. 2B). In some embodiments, the product stream exits coke drum 210 via line 214 using valve 215 and is combined with a product stream via line 222 using valve 223 from coke drum 218 as discussed below and sent to fractionator 216 (see FIG. 2B).

In some embodiments, when the reaction of the heated one or more feedstocks comprising crude oil or the heated one or more feedstocks comprising a solid carbon-based material in one of a semi-solid state or a melted state and the heated petroleum residue-containing feedstock in coke drum 210 is complete based on, for example, time of reaction, a complete reaction or that coke drum 210 is substantially full or completely full of coke, the reaction and coking cycle ends and the one or more feedstocks comprising crude oil or the one or more feedstocks comprising a solid carbon-based material is transferred from coke drum 210 to another parallel coke drum, e.g., coke drum 218, to initiate another reaction and coking cycle of the one or more feedstocks comprising crude oil or the one or more feedstocks comprising a solid carbon-based material and the heated petroleum residue-containing feedstock, while a coke removal process is initiated in coke drum 210. The term “substantially full” shall be understood to mean that coke drum 210 has reached a target level, sometimes referred to as a target or desired outage. As discussed in further detail elsewhere herein, refinery management system 103 system is configured for monitoring system 200 (e.g., an example of at least a portion of refinery 101), including a fill level of coke drum 210, such as through predicting the fill level of coke drum 210 utilizing coke drum outage projection model 130, and automating supply (e.g., inlet flow of the one or more feedstocks) to coke drum 210 based on the current predicted fill level of coke drum 210 obtained via coke drum outage projection model 130, and a supply amount which coke drum outage projection model 130 indicates will lead to reaching a target or desired outage at an end of the feed cycle of coke drum 210.

In some embodiments, when the reaction and coking cycle in coke drum 210 is complete, the coke removal process begins in coke drum 210 and the one or more feedstocks comprising crude oil or the one or more feedstocks comprising a solid carbon-based material and the heated petroleum residue-containing feedstock is then sent to coke drum 218 for processing as discussed below. The coke removal process includes, for example, steaming, water cooling, coke cutting, and gas heating and draining. The wash liquid and vapor from the coke drum is discharged mostly into a blow down section. In some embodiments, the wash liquid and vapor can be indirectly sent to fractionator 216. The coke is removed from coke drum 210 for further processing (not shown).

System 200 further includes fractionator 216. In some embodiments, fractionator 216 may include one or more distillation columns. For example, the product stream comprising a gas phase comprising hydrocarbons and hydrogen obtained in coke drum 210 and optionally the product stream obtained in coke drum 218, as discussed below, may be separated into one or more hydrocarbon fractions. The hydrocarbons present in the product stream can be in various forms. For example, in some embodiments, the product stream may include dry gases (e.g., one of more of hydrogen, methane, and ethane), liquefied petroleum gases (e.g., one or more of propane and butane), light olefins (e.g., one or more of ethylene, propylene, and butylene-based olefins), gasoline (e.g., a boiling range of C₅ to about 221° C.), a light gas oil (e.g., a boiling range of about 221° C.+ to about 343° C.) and heavy bottoms such as a heavy gas oil (e.g., a boiling range of about 343° C.+ to final boiling temperature).

In some embodiments, the product stream obtained in coke drum 210 and coke drum 218 may include one or more of dry gases (e.g., one of more of hydrogen, methane, and ethane), liquefied petroleum gases (e.g., one or more of propane and butane), light olefins (e.g., one or more of ethylene, propylene, and butylene-based olefins), gasoline (e.g., a boiling range of C₅ to about 221° C.), kerosene (JET, 150° C. to ~300° C.), diesel (200° C. to 350° C.) and heavy bottoms such as a heavy coker gas oil (HCGO) and a heavy-heavy coker gas oil (HHCGO). For example, the processed one or more feedstocks comprising a solid carbon-based material can have a variety of cracked hydrocarbon products that may be separated into two or more constituent streams by conventional means. In non-limiting illustrative embodiments, constituent streams may include one or more of a fuel gas stream, an ethylene stream, a propylene stream, a butylene stream, a naphtha stream, an olefin stream, liquefied petroleum gas (LPG), a gasoline stream, a kerosene stream, a diesel stream, a light coker gas oil (LCGO), a heavy bottoms including one or more of an HCGO stream and an HHCGO stream, and other hydrocarbon streams.

In some embodiments, the product stream may comprise from about 10 wt. % to about 30 wt. % (e.g., from about 10 wt. % to about 25 wt. %) of gasoline boiling range hydrocarbons, as determined by ASTM D2887. In some aspects, gasoline boiling range hydrocarbons may comprise at least about 25 wt. % (e.g., at least about 30 wt. %, or about 40 wt. % to about 50 wt. %) of C₅ to C₁₀ hydrocarbons such as C₆ to C₈ aromatics including 20 to 50 mole percent unsaturated olefinic and aromatic compounds. The obtained gasoline fraction may be useful as high-quality gasoline fuel and/or naphtha fuel, or as a blending component for these fuels or may require further refinement or treatment.

In some embodiments, the product stream may comprise at least about 25 wt. % (e.g., about 25 wt. % to about 40 wt. %, or about 30 wt. % to about 40 wt. %) C₃ to C₅ olefins, as determined by ASTM D2887. In some embodiments, C₃ to C₅ product olefins can be directed to a petrochemical unit or to an alkylation unit to produce a bio-based high-octane gasoline by the reaction of an isoparaffin (e.g., isobutane) with one or more of the olefins (e.g., propylene and butylene).

Hydrocarbon fractions may undergo further processing before commercial use. In some aspects, a constituent stream may be further processed. In an illustrative embodiment, an olefinic constituent stream may be sent to an alkylation unit for further processing. For example, a C₃ olefin/paraffin mix stream of propane and propylene mix can be sent to and separated by a propane/propylene splitter (PP splitter) to produce pure streams of propane and propylene. In some embodiments, the propylene can be fed to a propylene polymerization unit to produce polypropylene.

In some embodiments, the pure propane may be fed to a propane dehydrogenation unit to make additional propylene, and then ultimately polypropylene in the propylene polymerization unit.

In addition, olefins from the constituent streams may be further separated and recovered for use in plastics and petrochemicals.

In some embodiments, C₄ and other hydrocarbon product streams, such as a heavy fraction, can be sent to appropriate refinery units for upgrading into clean gasoline, diesel, or jet fuel. The gasoline from the coke drum may be passed directly to a gasoline pool or further upgraded before being sent to a gasoline pool.

Hydrocarbon fuel products may be sold or further processed. Examples of further processing include blending, hydroprocessing, desulfurization, separation, or alkylating at least a portion of the hydrocarbon fuel product. Hydrocarbon fuel products may be used as a blend stock and combined with one or more petroleum fuel products and/or renewable fuels. Petroleum-based streams include gasoline, diesel, aviation fuel, or other hydrocarbon streams obtained by refining of petroleum. Examples of renewable fuels include ethanol, propanol, and butanol.

Returning back to FIGS. 2A and 2B, as mentioned above, one of the separated constituent streams in fractionator 216 is a heavy bottoms stream including, for example, an HCGO stream and/or an HHCGO stream. In some embodiments, the heavy bottoms stream such as the HCGO stream or the HHCGO stream is combined with a petroleum residue stream as discussed above. In some embodiments, the petroleum residue stream enters fractionator 216 via line 224 and exits fractionator 216 via line 225 with one of the heavy bottoms streams such as the HCGO stream or HHCGO stream and is sent to pump 226 as a petroleum residue-containing feedstock. Pump 226 can be any suitable pump as discussed above for transfer device 206 for increasing the pressure of the petroleum residue-containing feedstock for sending a first pressurized petroleum residue-containing feedstock to heating unit 234 via line 228.

The first pressurized petroleum residue-containing feedstock can be combined with an optional supplemental petroleum residue stream via line 230 to form a second pressurized petroleum residue-containing feedstock. The second pressurized petroleum residue-containing feedstock is received in heating unit 234 via line 232. Heating unit 234 can be any conventional heating unit known in the art. In some embodiments, heating unit 234 can provide heat to the second pressurized petroleum residue-containing feedstock using, for example, electric heating, microwave heating, ultrasonic heating, induction heating, direct electric energy, hot oil heat exchanger or sources or electromagnetic sources. In some embodiments, heating unit 234 can be a heat exchanger to transfer heat to the second pressurized petroleum residue-containing feedstock. In some embodiments, heating unit 234 can be a furnace heater.

In some embodiments, heating unit 234 heats the second pressurized petroleum residue-containing feedstock stream to generate a heated petroleum residue-containing feedstock having a temperature ranging from about 470° C. to about 560° C. In some embodiments, heating unit 234 heats the second pressurized petroleum residue-containing feedstock to generate a heated petroleum residue-containing feedstock having a temperature ranging from about 480° C. to about 550° C.

In some embodiments, the heated petroleum residue-containing feedstock is sent to coke drum 210 via line 236-1 where it is processed with the heated one or more feedstocks comprising crude oil or the heated one or more feedstocks comprising a solid carbon-based material in one of a semi-solid state or a melted state as discussed above (see FIG. 2A). In some embodiments, the heated petroleum residue-containing feedstock is sent to coke drum 210 via line 236-1 using valve 238 where it is processed with the one or more feedstocks comprising crude oil or the one or more feedstocks comprising a solid carbon-based material as discussed above (see FIG. 2B).

In some embodiments, the heated petroleum residue-containing feedstock is sent to coke drum 218 via line 236-2 (see FIG. 2A) where it is processed with another heated one or more feedstocks comprising crude oil or heated one or more feedstocks comprising a solid carbon-based material in one of a semi-solid state or a melted state (not shown) in a similar manner as discussed above for coke drum 210. In some embodiments, the heated petroleum residue-containing feedstock is sent to coke drum 218 via line 236-2 using valve 237 (see FIG. 2B). Coke drum 218 can be any conventional coke drum used in refinery processing units. Coke drum 218 further includes heating element 220 for further heating the other one or more feedstocks comprising crude oil or one or more feedstocks comprising a solid carbon-based material into one of a semi-solid state or a melted state and the heated petroleum residue-containing feedstock in coke drum 218. In some embodiments, heating element 220 is external to coke drum 218. In some embodiments, heating element 220 is internal to coke drum 218. Heating element 220 can be any of the heating elements discussed above for heating element 212. Although heating element 220 is shown as a single heating element, this is merely illustrative and any number of external and/or internal heating elements are contemplated for use in system 200.

Although it is shown that the heated petroleum residue-containing feedstock enters coke drum 218 via line 236-2, it is contemplated that heated petroleum residue-containing feedstock can enter coke drum 218 at more than one inlet and at any position of coke drum 218. For example, heated petroleum residue-containing feedstock can enter coke drum 218 at one or more of a bottom inlet, a middle inlet and a top inlet of coke drum 218.

In some embodiments, the heated one or more feedstocks comprising crude oil or the heated one or more feedstocks comprising a solid carbon-based material in one of a semi-solid state or a melted state and the heated petroleum residue-containing feedstock can undergo one or more reactions such as, for example, pyrolysis, thermal cracking, decomposition, crystallization, mesophase formation and annealing as discussed above for coke drum 210.

In some embodiments, the temperature, residence time and pressure in coke drum 218 for pyrolyzing and thermal cracking operations can be the same as discussed above for coke drum 210.

In some embodiments, when the reaction of the heated one or more feedstocks comprising crude oil or the heated one or more feedstocks comprising a solid carbon-based material in one of a semi-solid state or a melted state and the heated petroleum residue-containing feedstock in coke drum 218 is complete based on, for example, time of reaction, a complete reaction or that coke drum 218 is substantially full or completely full of coke, the reaction and coking cycle ends and the one or more feedstocks comprising crude oil or the one or more feedstocks comprising a solid carbon-based material is transferred from coke drum 218 to another parallel coke drum, e.g., coke drum 210, to initiate another reaction and coking cycle of the one or more feedstocks comprising a solid carbon-based material and the heated petroleum residue-containing feedstock, while a coke removal process is initiated in coke drum 218. The term “substantially full” shall be understood to mean that coke drum 218 has reached a target level, sometimes referred to as a target or desired outage. As discussed in further detail elsewhere herein, refinery management system 103 system is configured for monitoring system 200 (e.g., an example of at least a portion of refinery 101), including a fill level of coke drum 218, such as through predicting the fill level of coke drum 218 utilizing coke drum outage projection model 130, and automating supply (e.g., inlet flow of the one or more feedstocks) to coke drum 218 based on the current predicted fill level of coke drum 218 obtained via coke drum outage projection model 130, and a supply amount which coke drum outage projection model 130 indicates will lead to reaching a target or desired outage at an end of the feed cycle of coke drum 218.

In some embodiments, the pyrolyzing and thermal cracking operations result in a product stream comprising a gas phase comprising hydrocarbons and hydrogen and coke. When the reaction and coking cycle in coke drum 218 is complete, the reaction and coking cycle ends and the one or more feedstocks comprising a solid carbon-based material is then transferred from coke drum 218 to another parallel coke drum (not shown) to initiate its reaction and coking cycle and continuity without disruption of the coker system, while the coke removal process is initiated in the filled coke drum 218.

In some embodiments, the heated petroleum residue-containing feedstock is sent to coke drum 218 via line 236-2 where it can be subjected to coking followed by calcination to obtain needle coke in the absence of the one or more feedstocks comprising crude oil or the one or more feedstocks comprising a solid carbon-based material. In an illustrative embodiment, the heated petroleum residue-containing feedstock stream is sent to coke drum 218 as known in the art and subjected to coking under coking conditions to form an intermediate coke product. In an illustrative embodiment, the coking conditions include, for example, exposing the heated petroleum residue-containing feedstock to a temperature ranging from about 490° C. to about 500° C. for a time period ranging from about 12 hours to about 36 hours.

In an illustrative embodiment, as may be combined with one or more of the preceding paragraphs, the heated petroleum residue-containing feedstock can be subjected to coking in the presence of an aromatic component such as a polymer material followed by calcination to obtain needle coke. In an illustrative embodiment, the coking conditions include, for example, exposing the heated petroleum residue-containing feedstock and the aromatic component to a temperature ranging from about 500° C. to about 525° C. for a time period ranging from about 24 hours to about 48 hours.

In an illustrative embodiment, the heated petroleum residue-containing feedstock can be co-fed with the aromatic polymer material into coke drum 218. In another embodiment, a solution of the heavy cycle oil and the aromatic polymer material are fed into coke drum 218 such as a delayed coking unit. For example, the solution is obtained by dissolving the aromatic polymer material in the heated HCO and normal coke feed stream. In an embodiment, the solution can contain from about 0.1 to about 10 wt. % of the aromatic polymer material.

In an illustrative embodiment, the aromatic polymer material includes, for example, polystyrene. Styrene is also known as ethenylbenzene, vinylbenzene, or phenylethylene. The styrene-based monomer is then polymerized (facilitated by the vinyl group) to form a homo- or copolymer. For example, the styrene-based monomer is polymerized as a homopolymer to form polystyrene.

In an illustrative embodiment, as may be combined with one or more of the preceding paragraphs, the intermediate coke product obtained from coke drum 218 can be calcinated in a calciner under calcinating conditions to obtain needle coke. Suitable calcinating conditions include, for example, a temperature ranging from about 1250° C. to about 1400° C. and for a time period ranging from about 30 to about 60 minutes.

In some embodiments, an alternative method of graphitization can be used to convert the coke without typical calcining process such as by heat treatment, catalytic graphitization, and electrochemical and chemical treatment.

In an illustrative embodiment, as may be combined with one or more of the preceding paragraphs, when coke drum 210 is receiving the one or more feedstocks comprising crude oil or the one or more feedstocks comprising a solid carbon-based material from transfer device 206 for processing, valve 209 is in an open position and valves 207 and 215 are in a closed position (see FIG. 2B). While coke drum 210 is being filled with the one or more feedstocks comprising crude oil or the one or more feedstocks comprising a solid carbon-based material, valve 238 is in a closed position and valve 237 is in an open position so that coke drum 218 is receiving and processing the heated petroleum residue-containing feedstock via line 236-2. In addition, valve 223 is in an open position to allow the processed heated petroleum residue-containing feedstock to flow into fractionator 216 via line 222.

In an illustrative embodiment, as may be combined with one or more of the preceding paragraphs, when coke drum 210 has received the one or more feedstocks comprising crude oil or the one or more feedstocks comprising a solid carbon-based material from transfer device 206 for pre-heating the one or more feedstocks comprising crude oil or the one or more feedstocks comprising a solid carbon-based material for processing, valve 209 is in a closed position, valve 207 is in an open position and valve 215 is in an open position to allow the processed the one or more feedstocks comprising crude oil or one or more feedstocks comprising a solid carbon-based material to flow via line 214 into fractionator 216 with the processed heated petroleum residue-containing feedstock from coke drum 218 via line 222. While coke drum 210 is heating the one or more feedstocks comprising crude oil or the one or more solid carbon-based feedstocks for processing, valve 238 is in a closed position and valve 237 is in an open position so that coke drum 218 is receiving and processing the heated petroleum residue-containing feedstock. In addition, valve 223 is in an open position to allow the processed heated petroleum residue-containing feedstock to flow into fractionator 216 via line 222.

In an illustrative embodiment, as may be combined with one or more of the preceding paragraphs, when the one or more feedstocks comprising crude oil or the one or more feedstocks comprising a solid carbon-based material from transfer device 206 is heated in coke drum 210 via heating element 212, valves 207 and 209 will be in a closed position, and valve 238 is in an open position to allow the heated coke drum feed stream through valve 238 to flow the heated petroleum residue-containing feedstock into coke drum 210 for processing with the one or more feedstocks comprising a solid carbon-based material. In addition, valve 215 is in an open position to allow the processed one or more feedstocks comprising crude oil or one or more feedstocks comprising a solid carbon-based material and processed heated petroleum residue-containing feedstock to flow into fractionator 216 via line 214. While coke drum 210 is processing the one or more feedstocks comprising a solid carbon-based material and the heated petroleum residue-containing feedstock, valves 223 and 237 are in a closed position.

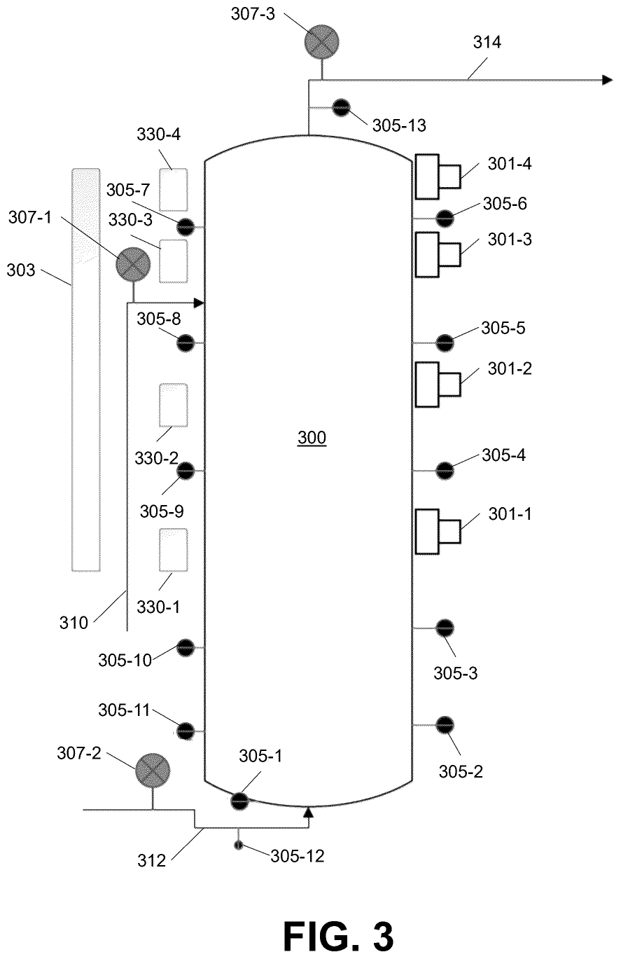

FIG. 3 shows coke drum 300 configured with various sensors (e.g., examples of sensors 112 associated with coke drums 110 in FIG. 1) which enable monitoring of a fill level of coke drum 300 (e.g., by refinery management system 103 in FIG. 1). Coke drum 300 includes anti-foam injection line 310, feed line 312 and vapor outlet line 314. The sensors include a set of nuclear sensors 301-1, 301-2, 301-3 and 301-4 (collectively, nuclear sensors 301), a continuous intensity measurement sensor 303 which utilizes continuous point source intensity measurement sensors 330-1, 330-2, 330-3 and 330-4 (collectively, continuous point source intensity measurement sensors 330), temperature sensors 305-1, 305-2, 305-3, 305-4, 305-5, 305-6, 305-7, 305-8, 305-9, 305-11, 305-11, 305-12 and 305-13 (collectively, temperature sensors 305), and pressure sensors 307-1, 307-2 and 307-3 (collectively, pressure sensors 307). Nuclear sensors 301 are positioned at different heights of coke drum 300, and provide continuous level measurements for coke drum 300 throughout a feed cycle. Nuclear sensors 301 include neutron backscatter devices, Gamma level transmission devices, etc. Continuous point source intensity measurement sensors 330 are similarly positioned at different heights of coke drum 300, and provide point source measurements of a fill level of coke drum 300. Temperatures sensors 305-1 through 305-11 are positioned at different points around coke drum 300, and provide temperature measurements at such different positions. Pressure sensor 307-1 is configured to monitor a pressure in anti-foam injection supply line 310. Pressure sensor 307-2 is configured to monitor a pressure in feed line 312, and temperature sensor 305-12 is configured to monitor a temperature in feed line 312. Pressure sensor 307-3 is configured to monitor a pressure in vapor outlet line 314, and temperature sensor 305-13 is configured to monitor a temperature in vapor outlet line 314.

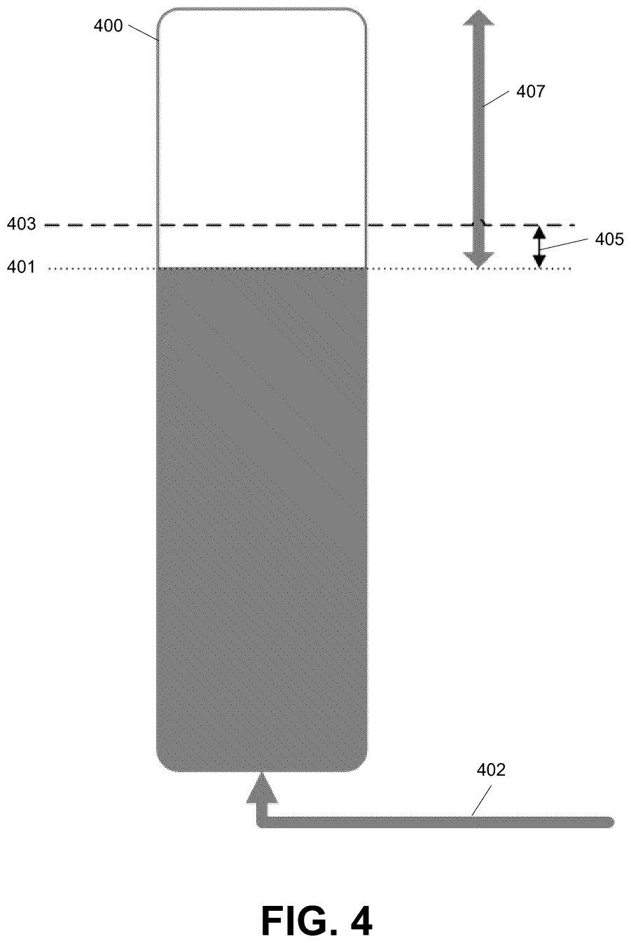

FIG. 4 shows coke drum 400 with feed line 402. In the FIG. 4 example, coke drum 400 is shown as being filled to actual fill level 401 that is less than target fill level 403. The FIG. 4 example illustrates a case where there is a missed target 405 (i.e., a difference between target fill level 403 and actual fill level 401). The difference between a top of the coke drum 400 and the actual fill level 401 is the “outage” 407 of coke drum 400. In conventional approaches, human operators rely on experience to control a supply from feed line 402 to coke drum 400 to meet a target outage (i.e., target fill level 403). Such a manual approach, however, relies heavily on the skill and expertise of operators and is thus subject to error and missing the target outage (i.e., missed target 405). In illustrative embodiments, a quantitative approach is utilized which provides an improved model (e.g., coke drum outage projection model 130) for predicting outage 407 of coke drum 400 with higher accuracy, and for prescribing a flow rate (i.e., of feed line 402) to meet target fill level 403. This prescribed flow rate for meeting target fill level 403 may include a risk-based parameter as discussed elsewhere herein. Each foot of outage leads to lost value. Conventional approaches which rely on human operator expertise for controlling the flow rate of feed line 402 to coke drum 400 may lead to significant missed target 405 (e.g., an average of three or more feet). The qualitative approach described herein can significantly reduce missed target 405 (e.g., down to about one foot).

Referring again to FIG. 1, in some embodiments a data analytics system is implemented as part of refinery management system 103 via coke drum outage projection model 130, with defined physical boundaries and thermodynamic system equations configured for continuously monitoring and evaluating a status of coke drums 110 of refinery 101. Such monitoring may include pulling data from sensors 112 (e.g., raw sensor data), with such data being used to determine or derive various parameters and metrics, including one or more of the following variables that may be fully or partially used in coke drum outage projection model 130 (e.g., in an objective function thereof, with defined weights for the different variables): mass balance based on inlet flow of coke drums 110; a level of coke, residual or other materials in coke drums 110 continuously (e.g., with non-intrusive ones of sensors 112, which may include Gamma, X-ray, Neutron or other nuclear sensors); a condition of coke drums 110 based on skin temperature thereof measured via sensors 112; inlet and outlet pressure and temperature of coke drums 110, which provide a proxy for enthalpy and reaction rate; etc.

After opening coke drums 110, the tension of coke drums 110 is measured and used to automatically verify the outage against the prediction produced by coke drum outage projection model 130, which may be used to update the coke drum outage projection model 130. Further, the quality of feed to coke drums 110, including features such as density, molecular composition, and viscosity, may be used to update and train coke drum outage projection model 130 (e.g., continuously, at regular intervals, on detecting deviations between the actual measurements of the outage level and the outage level predictions, etc.). Further, if changes in feed composition or quality is detected (e.g., use of alternative feed, such as fuel oil, tar, asphalt, solid or slurry, heavy cycle oil, etc.), coke drum outage projection model 130 is configured to adjust the outage level prediction either actively or passively. Further, based on a time and date, refinery management system 103 is configured to recognize abnormal conditions (e.g., foaming levels), and is able to modify process conditions through tuning controls 114 (e.g., introducing antifoam injections, controlling feed temperature and flowrate, etc.). Coke drum outage projection model 130 may also be adjusted to improve and balance the safety margin for measurement and prediction of outage in coke drums 110.

Measurement of the height or fill level of coke drums 110 (e.g., outage predictions generated via coke drum outage projection model 130) is of safety importance, as overfilling coke drums 110 with coke and residual can have significant safety and reliability consequences, including overhead plugging, carryover, process upset, etc. Being able to calculate outage of coke drums 110 with a certain accuracy, and having a good view of the current fill level or outage of coke drums 110, provides a critical role in optimization and adjusting controls 114 of refinery 101 (e.g., adjusting feed to coke drums 110 to minimize potential risk of overfill and maximize profitability). Further, optimizing feed cycle time can help to preserve drum life of coke drums 110, with improved thermal cycling and feed rate adjustments.

Coke drum outage projection model 130 is configured with various options. Coke drum outage projection model 130 is dynamic, and has the capability to utilize machine learning algorithms and techniques for continuous adjustment and optimization. In some examples, coke drum outage projection model 130 utilizes artificial intelligence and machine learning to monitor various variables and data (e.g., from sensors 112) across refinery 101, including but not limited to composition, carbon content, Hardgrave index, sulfur, nitrogen, metals, coke type, Volatile Carbonaceous Matter (VCM), particle size, density, feed temperature, foam level, coke drum temperature profile and density, etc., to adjust and optimize one or more objective functions of coke drum outage projection model 130. Further, the one or more objective functions of coke drum outage projection model 130 can be adjusted to consider the potential risk versus profitability to improve safety and reliability.

Coke drum outage projection model 130 leverages data analytics, mass balance, kinetic and scientific principles to estimate coke drum outage during feed cycles of coke drums 110. Coke drum outage projection model 130 is dynamic and will update while coke drums 110 are being fed based on instrumentation (e.g., data from sensors 112), predictions, and ongoing as well as historic data. One or more objective functions of coke drum outage projection model 130 can be adjusted for safety and accuracy of prediction. Although coke drum outage projection model 130 utilizes mass balance and reaction principles as its backbone, advanced artificial intelligence and machine learning techniques are used to adjust and update the one or more objective functions of coke drum outage projection model 130. Through embedding artificial intelligence and machine learning techniques, the accuracy of coke drum outage projection model 130 is improved. Further, coke drum outage projection model 130 allows for dynamic changes and flexibility, as well as built-in safety constituents to avoid overfeeding coke drums 110. Coke drum outage projection model 130 can be adjusted to optimize VCM or yield versus coke made by proposing process changes including transfer temperature, coke drum pressure, etc.

Predicting, estimating and monitoring outage for coke drums 110, in some examples, involves a combination of advanced techniques and technologies. Data analytics and machine learning utilizes historical data from operations of refinery 101 (e.g., coker operations involving coke drums 110) and machine learning models to predict outages of coke drums 110 by identifying patterns and anomalies, which are used to train coke drum outage projection model 130 (e.g., to recognize early warning signs of potential issues).

Real-time monitoring systems are implemented that track critical parameters, such as temperatures, pressures and flow rates (e.g., from sensors 112) that can help in early detection of problems. In some examples, sensors 112 include advanced sensors and IoT devices that can provide continuous data for analysis, like foaming detection. Sensors 112, in some examples, include nuclear sensors such as neutron backscatter systems, which are non-contact level systems that can be used to monitor internal conditions of coke drums 110, providing valuable data for predicting outages. Using predictive maintenance strategies such as vibration analysis and thermal imaging can help to identify equipment at refinery 101 that is likely to fail. This allows for proactive maintenance, reducing the likelihood of unexpected outages. Thus, if instrumentation such as one or more of sensors 112 starts to show deterioration or failure, the coke drum outage projection model 130 can detect this and recommend appropriate remedial action.

Simulation and modeling techniques are further leveraged, where computational models can simulate operations in refinery 101 under various conditions to predict potential failures. Such computational models can help in understanding the impact of different variables on performance. Further, controls 114 provide advanced control systems that can adjust operations in refinery 101 in real-time based on data collected from sensors 112 to help maintain optimal conditions and prevent failures or outages. By combining these and other techniques, refinery management system 103 provides a comprehensive strategy for predicting, estimating and monitoring outage of coke drums 110, providing improved reliability and efficiency in refinery 101.

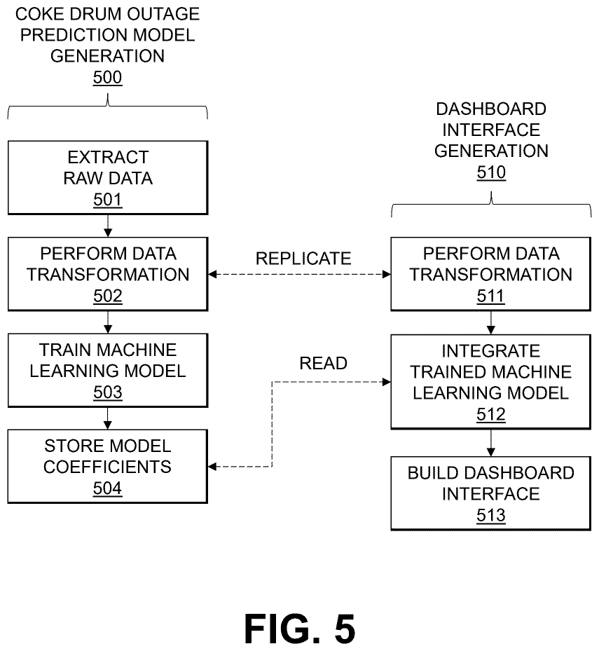

FIG. 5 shows workflow 500 for generation of coke drum outage projection model 130 and a workflow 510 for generation of dashboard interface 132. Workflow 500 begins with extracting raw data 501 (e.g., time series data from sensors 112), followed by performing data transformation 502. The data transformation may include converting time series data from sensors 112 into metrics or data structures suitable for use in building a machine learning model. Workflow 500 continues with training a machine learning model 503 (e.g., coke drum outage projection model 130) utilizing the transformed data, and storing model coefficients 504 for the trained machine learning model. Workflow 500 may be implemented utilizing any suitable programming language. In some examples, Python is used and various libraries are leveraged for different steps in workflow 500, such as: using the “chippy” library (i.e., a Chevron proprietary Python package for PI data extraction) for extracting raw data 501; using the “pandas” library for performing data transformation 502; using “sklearn,” “statsmodels,” and automated machine learning for model selection and for training machine learning model 503; and using an Asset Framework (AF) database for storing model coefficients 504.

Workflow 510 begins with performing data transformation 511, which may be based on replicating transformed data from step 502 in workflow 500, followed by model integration 512 where the machine learning model trained in step 503 of workflow 500 is integrated through reading the model coefficients stored in step 504 of workflow 500. Workflow 510 continues with building dashboard interface 132 utilizing the integrated model in step 513. Workflow 510 may be implemented utilizing any suitable analytics platform. In some examples, Workbench Analysis tools provided in the Seeq platform are utilized.

Workflows similar to those shown in FIG. 5 may also be used for model retraining and standardized deployment. In some examples, an asset hierarchy and data are provided to an analytics platform, which identifies feed cycles, filters the data and generates features (e.g., the data transformations performed in step 502 of workflow 500 and step 511 of workflow 510). The transformed data, also referred to as preprocessed data, is leveraged to perform model training and retraining, and to maintain a model registry and perform drift monitoring, with an output of model coefficients for coke drum outage projection model 130. This enables faster model development, as features are only generated once (e.g., in Seeq) instead of needing to regenerate (e.g., in Python) for model training. Deploying a new model to multiple assets may be done through the spy library, which removes the need for multiple versions of workbooks and dashboards in Seeq. This makes deployment to refinery 101, and other refineries, easier and more efficient.

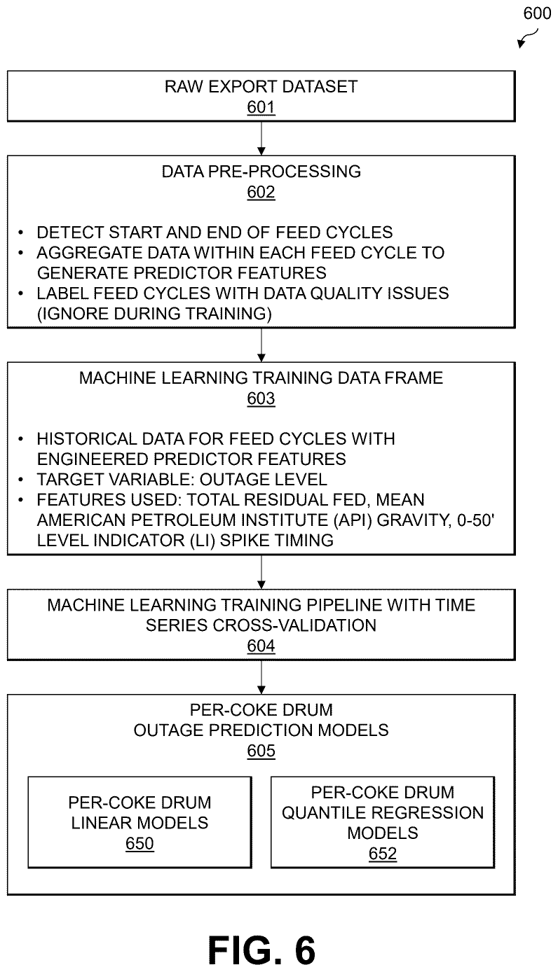

FIG. 6 shows workflow 600 for a machine learning training pipeline. Workflow 600 begins with a raw export dataset 601 including historical data obtained from operation of one or more refineries (e.g., refinery 101), where a refinery may include a set of three modules, where each module includes two coke drums for a total of six coke drums. Raw export dataset 601 includes per-coke drum or per-module data. For each coke drum or module, a number of tags or metrics are sampled (e.g., 15 or more tags) at a frequency of one minute. For two years of historical data, this includes approximately one million rows with fifteen columns per coke drum or module. Workflow 600 continues with data pre-processing 602, where the start and end of feed cycles are detected, and data within each feed cycle is aggregated to generate predictor features. Any feed cycles with data quality issues may be labeled, and their data will be ignored during training. This results in creation of a machine learning training data frame 603, which includes the historical data for feed cycles with engineered predictor features (e.g., approximately 600 feed cycles per coke drum, with more than one hundred engineered predictor features). The target variable is the coke drum outage level. The features which are used, in some embodiments, include the total residual fed to the coke drum during each feed cycle, American Petroleum Institute (API) gravity, and zero-to-fifty percent (0-50) level indicator (LI) spike timing. Workflow 600 continues with a machine learning training pipeline 604 with time series cross-validation, which produces per-coke drum outage prediction models 605 including per-coke drum linear models 650 (sometimes referred to as “P50” models) and per-coke drum quantile regression models 652 (sometimes referred to as “P10” models).

An example implementation of coke drum outage projection model 130 will now be described. In this example implementation, the training information included approximately 15 months of feed cycle data in a training set and 2 months of feed cycle data in a test set. Feed cycles excluded from the training include those with invalid outage (e.g., a same outage reading as a prior feed cycle, outage less than a designated threshold such as 15 ft), feed cycles which are longer than a first threshold duration (e.g., longer than 14 hours) or which are less than a second threshold duration (e.g., less than 10 hours). Data extraction is performed using the “chippy” Python package, with data transformations being performed utilizing the “pandas” Python package. The coke drum outage projection model 130 is trained using Python and automated machine learning for model selection, including evaluation of various algorithms (e.g., Random Forest, Gradient Boosting, multi-layer perceptron (MLP), etc.). Model and hyperparameter selection in this example uses 5-fold cross validation, with a generalized linear model (GLM) in this example consistently having the best training and test set performance. The GLM fit is performed using linear regression with one or more of: L1 (Lasso) regularization, L2 (Ridge) regularization, elastic net regularization, and robust regression using a loss function such as Huber loss. Feature selection is performed through evaluating variables through a stepwise selection process, including analyzing the following variables: residual fed (flowrate); specific gravity weighted residual fed (flowrate with API gravity); coke level 0-50% spike time (in hours, h); 35 ft level spike; dP (bottom pressure minus overhead pressure); X-ray level; and coke level. In some examples, the final variables in the GLM include the residual fed (flowrate) and the coke level 0-50% spike time, using 75 as a threshold. It is noted that the end of cycle prediction may be more accurate with more variables, but predicting the end of cycle values for additional variables may introduce more error.

The final GLM may utilize an objective function for making real-time end of feed cycle outage predictions, where the objective function is a function of multiple variables. In some examples, the variables used in the objective function include an intercept, residual fed, coke level spike time, and API gravity per coke drum. An example objective function which may be used is:

Outage Prediction=function (b, r, Projected Residual Fed, s, CL Spike Time)

The outage prediction (Outage Prediction) is in units of feet (ft), the residual fed (Projected Residual Fed) is in units of Mbbl, and the coke level spike time (CL Spike Time) is in units of hours (h), measured from the start of the feed cycle. The GLM may utilize coefficients b, r, s that are generated for each individual coke drum. In some examples, the end of feed cycle outage prediction is made, utilizing the above-described objective function, starting from the time when the coke level spike time (CL Spike Time) reaches a designated threshold value for the first time.

The projected residual fed value may be determined according to:

$$Projected Residual Fed = Current Residual Fed + Current Flowrate * Remaining Cycle Duration$$

In this example, the GLM includes an assumption that Remaining Cycle Duration=12 hours−Elapsed Time in Cycle, and once the cycle has surpassed 12 hours, the value for Remaining Cycle Duration is set to a fixed value of 5 minutes. The target flowrate (e.g., for a specific target outage, such as 25 ft) can be derived from the GLM by solving for a value of Current Flowrate that meets the specified target outage using the equations above.

It is noted that the particular set of features used in coke drum outage projection model 130 in the above example implementation are presented by way of illustrative example only. In other examples, coke drum outage projection model 130 may utilize various other combinations of features. For example, a new feature may be used which combines the residual fed (Current Residual Fed) with a flowrate weighted specific gravity (Flowrate Weighted SG) into one feature, denoted SG Weighted Residual Fed, which characterizes the residual fed scaled based on the weight of the residual as measured by specific gravity (e.g., derived from API gravity). In another example, different level indicators (e.g., 35 ft, 50 ft, etc.) are evaluated to account for potential data quality issues with the different level indicators. Further, coke level may be used as a replacement for X-ray sensor values to evaluate if the overall performance improves due to more consistent feed cycle behavior for the coke level. In some cases, removal of certain features (dP, X-ray sensor values, dP and X-ray sensor values) is evaluated to determine if the model can be simplified. Experimental results indicate that SG Weighted Residual Fed is a good replacement feature providing similar performance as the baseline but with a reduction in the number of variables. Thus, in some examples, coke drum outage projection model 130 may utilize a feature set of SG Weighted Residual Fed, CL Spike Time and X-ray sensor values or coke level values.

To forecast a total SG Weighted Residual Fed at the end of a feed cycle while the feed cycle is in progress (e.g., in the middle of the feed cycle), the following approach may be used. The remaining time in the feed cycle is calculated as described above. An assumption is made that the API gravity of the residual fed is relatively constant during the feed cycle, which leads to some uncertainty. This uncertainty may be reduced through analyzing the variance of API gravity within the feed cycle and determining the potential impact of this variance on the forecast. A further assumption is made that the flowrate in the remainder of the feed cycle is the same as the average flowrate in the feed cycle thus far. The CL Spike Time may be forecast, or the outage forecast may begin once this spike is hit (e.g., an average of 6-7 hours into the feed cycle). Further, a model may be built to forecast X-ray sensor values or the coke level at the end of the feed cycle while the feed cycle is in progress.

Experimental results indicate that the best performance is achieved when using the most features, though there are diminishing returns when more than 3-5 features are utilized. Further, using just two variables (Residual Fed and CL Spike Time) may provide acceptable performance, assuming that prediction can start after the CL Spike Time has reached a designated threshold value. Improved performance is provided (e.g., approximately 0.2 MAE) through adding coke level features, though the coke level needs to be forecast. Additional performance improvement may be achieved through addition of the dP feature, which also requires forecasting.

In some examples, coke drum outage projection model 130 is configured to utilize a GLM that takes into account a cumulative amount of residual fed in the feed cycle (Residual Fed), coke level spike time (CL Spike Time) and mean API gravity (API Gravity Mean) variables, with each of such variables having an associated coke drum-specific coefficient:

$$Outage Prediction = function ( b , r , \\ Projected Residual Fed , s , CL Spike Time , t , API Gravity Mean )$$

where b, r, s and t are GLM coefficients determined through training of the GLM using historical data for feed cycles of coke drums 110. The CL Spike Time variable may be calculated through subtracting a time since the coke level has reached a designated threshold from an elapsed time of the feed cycle. The API Gravity Mean variable may be calculated according to determining a running aggregate of the average API gravity throughout the feed cycle. The Residual Fed variable may be calculated through integrating the flowrate of the residual over the time elapsed in the feed cycle. The Projected Residual Fed variable may be calculated by determining a time remaining in the feed cycle, multiplying the determined time remaining in the feed cycle by the flowrate of the residual, and adding the value of the Residual Fed variable. The target flowrate (e.g., for a specific target outage, such as 25 ft) can be derived from the GLM.

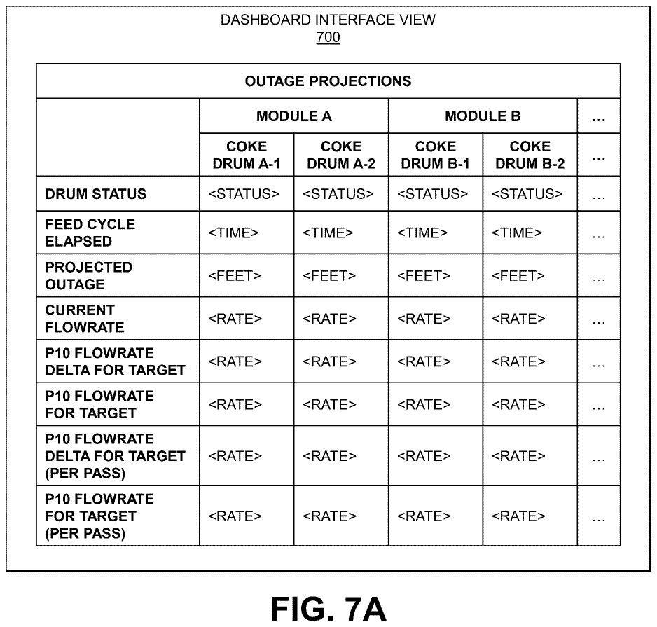

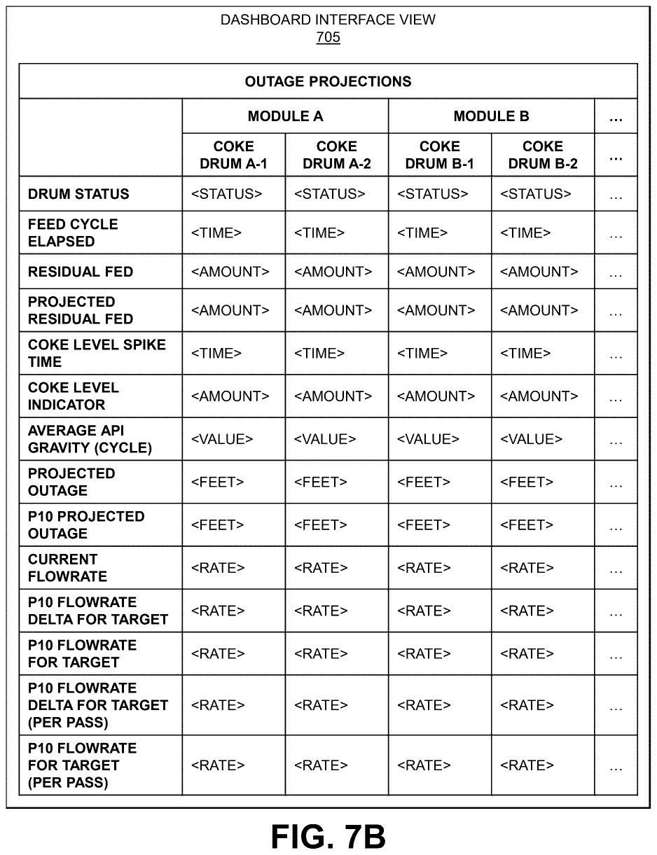

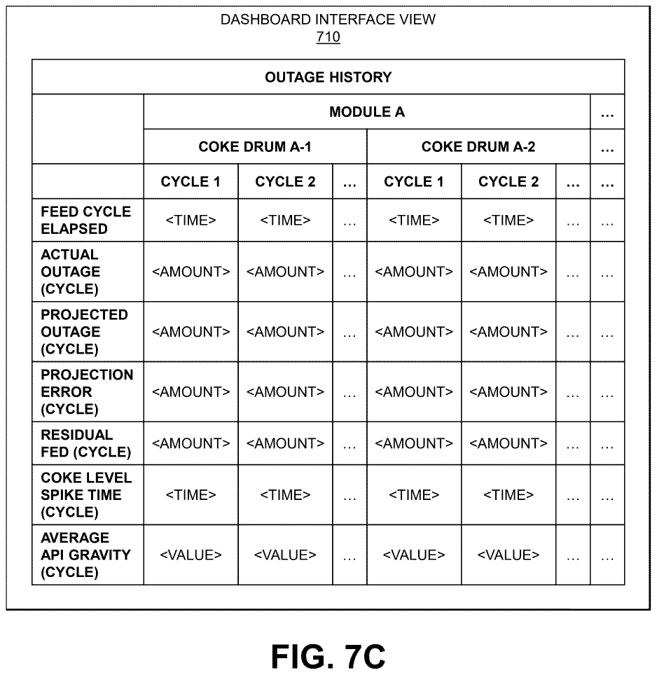

FIGS. 7A-7C show respective dashboard interface views 700, 705 and 710 (e.g., of dashboard interface 132). FIG. 7A shows dashboard interface view 700, illustrating a simplified view of outage projection information obtained from sensors 112 and generated utilizing coke drum outage projection model 130. In this example, dashboard interface view 700 includes projections that assume a feed cycle of some designated threshold duration (e.g., 12 hours), where projections are made available after a coke level indicator (e.g., a 0-50% coke level indicator) has exceeded a designated threshold value. The outage projection information includes information for each coke drum within each module (e.g., assuming a refinery 101 that includes coke drums 110 separated into three modules denoted Module A, Module B and Module C, with two coke drums in each module denoted Coke Drum A-1, Coke Drum A-2, Coke Drum B-1, Coke Drum B-2, Coke Drum C-1 and Coke Drum C-2). The information includes metrics such as: the drum status (e.g., cut, feed, cool, preheat, etc.); feed cycle elapsed (a time in hours, h); projected outage (an amount in feet, ft); a current flowrate (in thousand barrels of oil per day, Mbbl/d); a P10 flowrate delta for a target (in Mbbl/d), a P10 flowrate for the target (in Mbbl/d); a P10 flowrate delta for the target per pass (in Mbbl/d); and P10 flowrate for the target per pass (in Mbbl/d). Here, “P10” refers to a projection produced by coke drum outage projection model 130 which meets a target outage (e.g., 25 ft) with a 10% chance of exceeding the target.

FIG. 7B shows dashboard interface view 705, illustrating a more advanced view of outage projection information obtained from sensors 112 and generated utilizing coke drum outage projection model 130. In this example, dashboard interface view 705 (like dashboard interface view 700) includes projections that assume a feed cycle of a designated threshold duration (e.g., 12 hours). Further, projections are available after a coke level indicator exceeds a designated threshold value, which generally occurs after a few hours into the feed cycle although this may occur later for feed cycles with low flow rates. In addition to the information and metrics shown in dashboard interface view 700, dashboard interface view 705 includes: an amount of residual fed (in Mbbl/d); a projected amount of residual fed (in Mbbl/d) based on current flowrate at the projected end of the feed cycle; a spike time indicating an elapsed time (in hours, h) in the feed cycle when a coke level indicator crosses a designated threshold value (where later times mean less coke); a coke level indicator; an average API gravity for the feed cycle (a running average of API gravity) where a higher value indicates lighter feed and less coke; a projected outage (in ft), with an error (i.e., of about ±1 foot); and a P10 projected outage (in ft) which is a 10% quantile prediction produced by coke drum outage projection model 130 with an error (i.e., of about ±2.5 ft) having a 10% chance that the actual coke level is higher.

FIG. 7C shows dashboard interface view 710, illustrating coke drum outage history information. In this example, dashboard interface view 710 shows the outage history for some defined amount of time. The defined amount of time may default, for example, to showing feed cycle information for the last 7 days. Dashboard interface 132, however, may permit a user to adjust the outage history information shown (e.g., for more or less days, to show daily, weekly or monthly averages over some configurable length of time, etc.). The outage history information shown in dashboard interface view 710 includes, for each coke drum: a feed cycle elapsed time (in hours, h); an actual outage for the feed cycle (in ft); a projected outage for the feed cycle (in ft) produced by coke drum outage projection model 130; a projection error for the feed cycle (in ft) representing a different between the actual and projected outages for the feed cycle; an amount of residual fed in the feed cycle (in Mbbl); a 0-50 spike time for the feed cycle (in hours, h); and an average API gravity for the feed cycle. In some examples, if the projection error for the feed cycle for a particular one of coke drums 110 exceeds a designated threshold, this may indicate that there is a sensor issue for one or more of sensors 112 associated with that particular one of coke drums 110 and remedial action may be taken.

It should be noted that the particular metrics and information shown in dashboard interface views 700, 705 and 710 may vary or be user-configurable. For example, a user may custom-configure which metrics or other information are displayed in “simplified” and “advanced” views of the outage projections in dashboard interface views 700 and 705. Further, as noted above, a user may configure the time periods for the outage history information shown in dashboard interface view 710.

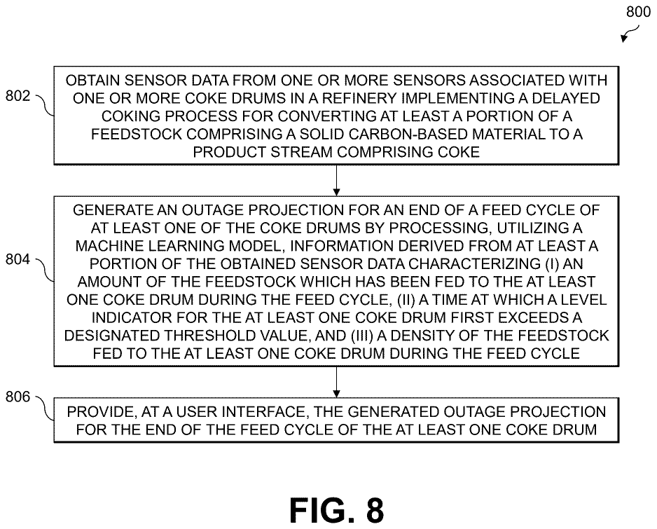

FIG. 8 shows an exemplary process 800 for generation of coke drum outage projections. It is to be understood that this particular process is only an example, and that additional or alternative processes for generation of coke drum outage projections may be used in other embodiments. In this embodiment, process 800 includes steps 802 through 806. These steps are assumed to be performed by refinery management system 103 utilizing coke drum outage projection model 130 and dashboard interface 132.

In step 802, sensor data is obtained from sensors 112 associated with coke drums 110 in refinery 101, where coke drums 110 implement a delayed coking process as described above with respect to FIGS. 2A and 2B.

In step 804, an outage projection for an end of a feed cycle of one of coke drums 110 is generated by processing, utilizing coke drum outage projection model 130, information derived from at least a portion of the sensor data obtained in step 802. The information derived from at least a portion of the sensor data characterizes (i) an amount of the feedstock which has been fed to said one of coke drums 110 during the feed cycle, (ii) a time at which a level indicator for said one of coke drums 110 first exceeds a designated threshold value, and (iii) a density of the feedstock fed to said one of coke drums 110 during the feed cycle. The level indicator for said one of coke drums 110 may be determined based at least in part on sensor data from nuclear ones of sensors 112, such as neutron backscatter systems. The density of the feedstock fed to said one of coke drums 110 may be determined based at least in part on calculating a running average of API gravity of the feedstock fed to said one of coke drums 110 during the feed cycle.

In step 806, the outage projection generated in step 802 is provided via dashboard interface 132.

As discussed in further detail above, coke drum outage projection model 130 may be a machine learning model, such as a GLM.

In some examples, step 804 is triggered based at least in part on detecting one or more designated conditions during the feed cycle for said one of coke drums 110, where the one or more designated conditions may comprise detecting that the level indicator for said one of coke drums 110 exceeds the designated threshold value.

Process 800 may further include generating, utilizing coke drum outage projection model 130, a target flowrate for providing feedstock to said one of coke drums 110, the target flowrate being one which ensures that said one of coke drums 110 reaches a designated target outage projection at the end of the feed cycle. The target flowrate may be generated in response to detecting that the outage projection generated in step 802 is more than a threshold amount different than the designated target outage projection. Controls 114 may be actuated to adjust a current flowrate of the feedstock to said one of coke drums 110 to the target flowrate.

Coke drum outage projection model 130 may be trained for said one of coke drums 110 utilizing historical data for a plurality of feed cycles of said one of coke drums 110. Coke drum outage projection model 130 may be re-trained for said one of coke drums 110 in response to detecting that an error in outage projections generated by coke drum outage projection model 130 exceeds a designated threshold in a designated number of most recent feed cycles for said one of coke drums 110.

The outage projection generated in step 804 may be associated with a configurable risk parameter (e.g., derived from quantile regression). The configurable risk parameter may characterize a percentage change that the generated outage projection will exceed a target outage projection for said one of coke drums 110.

Process 800 may further include detecting, based at least in part on the outage projection generated in step 802, one or more anomalous conditions of said one of coke drums 110 during the feed cycle. In response to detecting the one or more anomalous conditions, various actions may be taken including adjusting controls 114 (e.g., to adjust a feed temperature of the feedstock to said one of coke drums 110 during a remainder of the feed cycle, to provide an antifoam injection to said one of coke drums 110, etc.).

The particular processing operations and other system functionality described in conjunction with the flow diagram of FIG. 8 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 8 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

According to an aspect of the present disclosure, an apparatus comprises at least one processing device comprising a processor coupled to a memory, the at least one processing device being configured:
to obtain sensor data from one or more sensors associated with one or more coke drums in a refinery implementing a delayed coking process for converting at least a portion of a feedstock to a product stream comprising coke,
to generate an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle, and
to provide, at a user interface, the generated outage projection for the end of the feed cycle of said at least one of the one or more coke drums.

In one or more additional illustrative embodiments, as may be combined with the preceding paragraphs, the machine learning model comprises a generalized linear model.

In one or more additional illustrative embodiments, as may be combined with the preceding paragraphs, generating the outage projection for the end of the feed cycle of said at least one of the one or more coke drums is triggered based at least in part on detecting one or more designated conditions during the feed cycle for said at least one of the one or more coke drums. The one or more designated conditions during the feed cycle may comprise detecting that the level indicator for said at least one of the one or more coke drums exceeds the designated threshold value.

In one or more additional illustrative embodiments, as may be combined with the preceding paragraphs, the at least one processing device is further configured to generate, utilizing the machine learning model, a target flowrate for providing the feedstock to said at least one of the one or more coke drums which reaches a designated target outage projection at the end of the feed cycle. Generating the target flowrate may be responsive to detecting that the outage projection for the end of the feed cycle for said at least one of the one or more coke drums is more than a threshold difference from the designated target outage projection. The at least one processing device is further configured to actuate one or more controls associated with said at least one of the one or more coke drums to automatically adjust a current flowrate of the feedstock to said at least one of the one or more coke drums to the target flowrate.

In one or more additional illustrative embodiments, as may be combined with the preceding paragraphs, the at least one processing device is further configured to train the machine learning model for said at least one of the one or more coke drums utilizing historical data for a plurality of feed cycles of said at least one of the one or more coke drums. The at least one processing device may be further configured to re-train the machine learning model for said at least one of the one or more coke drums in response to detecting that an error in outage projections generated by the machine learning model exceeds a designated threshold in a designated number of most recent feed cycles for said at least one of the one or more coke drums.

In one or more additional illustrative embodiments, as may be combined with the preceding paragraphs, the generated outage projection is associated with a configurable risk parameter. The configurable risk parameter may characterize a percentage chance that the generated outage projection exceeds a target outage for said at least one of the one or more coke drums.

In one or more additional illustrative embodiments, as may be combined with the preceding paragraphs, the at least one processing device is further configured to detect, based at least in part on the generated outage projection for the feed cycle, one or more anomalous conditions of said at least one of the one or more coke drums during the feed cycle. The at least one processing device may be further configured, responsive to detecting the one or more anomalous conditions, to at least one of: adjust a feed temperature of the feedstock to said at least one of the one or more coke drums during a remainder of the feed cycle; and provide an antifoam injection to said at least one of the one or more coke drums.

In one or more additional illustrative embodiments, as may be combined with the preceding paragraphs, the level indicator for said at least one of the one or more coke drums is determined based at least in part on sensor data from one or more nuclear sensors associated with said at least one of the one or more coke drums. The one or more nuclear sensors may comprise at least one of: one or more neutron backscatter systems; one or more Gamma-ray sensors; and one or more X-ray sensors.

In one or more additional illustrative embodiments, as may be combined with the preceding paragraphs, the density of the feedstock fed to said at least one of the one or more coke drums during the feed cycle is determined based at least in part on calculating a running average of API gravity of the feedstock fed to said at least one of the one or more coke drums during the feed cycle.

According to another aspect of the present disclosure, a method performed by at least one processing device comprising a processor coupled to a memory comprises:
obtaining sensor data from one or more sensors associated with one or more coke drums in a refinery implementing a delayed coking process for converting at least a portion of a feedstock to a product stream comprising coke,
generating an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle, and
providing, at a user interface, the generated outage projection for the end of the feed cycle of said at least one of the one or more coke drums.

In one or more additional illustrative embodiments, as may be combined with the preceding paragraphs, the method further comprises generating, utilizing the machine learning model, a target flowrate for providing the feedstock to said at least one of the one or more coke drums which reaches a designated target outage projection at the end of the feed cycle.

According to another aspect of the present disclosure, a computer program product comprises a non-transitory processor-readable storage medium having stored therein program code of one or more software programs, where the program code when executed by at least one processing device causes the at least one processing device:
to obtain sensor data from one or more sensors associated with one or more coke drums in a refinery implementing a delayed coking process for converting at least a portion of a feedstock to a product stream comprising coke,
to generate an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle, and
to provide, at a user interface, the generated outage projection for the end of the feed cycle of said at least one of the one or more coke drums.

In one or more additional illustrative embodiments, as may be combined with the preceding paragraphs, the program code when executed by the at least one processing device further causes the at least one processing device to generate, utilizing the machine learning model, a target flowrate for providing the feedstock to said at least one of the one or more coke drums which reaches a designated target outage projection at the end of the feed cycle.

In various embodiments, aspects of refinery 101 and/or refinery management system 103 may be implemented using one or more information processing systems. For example, sensors 112 and/or controls 114 of refinery 101, as well as coke drum outage projection model 130 and/or dashboard interface 132, may be implemented at least in part using one or more information processing systems. FIG. 9 shows an example information processing system 900 that may be utilized to implement these and other aspects described herein. In FIG. 9, information processing system 900 includes a plurality of processing devices 902-1, 902-2, 902-3, . . . 902-K (collectively, processing devices 902), which communicate with one another over network 904.

Aspects of refinery 101 and/or refinery management system 103 may be configured using one or more of processing devices 902 to implement its associated functionality. For example, algorithms for generating, training and utilizing coke drum outage projection model 130, and for implementing dashboard interface 132, may be implemented using one or more of processing devices 902, such as processing device 902-1, which comprises processor 910 and memory 912. Processing device 902-1 may be suitably coupled to other components, such as sensors 112 and/or controls 114 of refinery 101. Processor 910 executes software program code stored in memory 912 in order to control the performance of processing operations and other functionality. Such functionality includes, but is not limited to, utilizing coke drum outage projection model 130 for generating outage predictions for coke drums 110, possibly through utilizing data obtained from sensors 112, and for populating dashboard interface 132 with the generated outage predictions for coke drums 110. Such functionality may further include utilizing coke drum outage projection model 130 in order to determine sets of values for controls 114 which will lead to obtaining a target outage levels for coke drums 110, and for actuation of controls 114 utilizing such determined sets of values. Outage predictions may be continuously monitored and updated throughout feed cycles of coke drums 110, with controls 114 being dynamically actuated with determined sets of values for obtaining the target outage levels for coke drums 110 throughout the feed cycles of coke drums 110. Processing device 902-1 also comprises network interface 914 that supports communication over one or more networks such as network 904.

Processor 910 may comprise, for example, a microprocessor, an application-specific integrated circuit (ASIC), a field-programmable gate array (FPGA), a central processing unit (CPU), an arithmetic logic unit (ALU), a digital signal processor (DSP), a graphical processing unit (GPU), a tensor processing unit (TPU), a video processing unit (VPU), a neural processing unit (NPU), a data processing unit (DPU), a System-On-Chip (SOC) or other types and arrangements of processing circuitry, as well as portions and combinations thereof.

Memory 912 stores software program code for execution by processor 910 in implementing portions of the functionality of processing device 902-1. A given such memory that stores such program code for execution by a corresponding processor is an example of what is more generally referred to herein as a processor-readable storage medium having program code embodied therein, and may comprise, for example, electronic memory such as static random-access memory (SRAM), dynamic random-access memory (DRAM) or other types of random-access memory (RAM), read-only memory (ROM), magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, embodiments of the invention may be implemented in the form of integrated circuits comprising processing circuitry configured to implement processing operations associated with the embodiments described herein.

Although not shown in FIG. 9, processing devices 902-2 through 902-K are assumed to be configured in a manner similar to that of processing device 902-1 with respective processors, memories and network interfaces.

Processing devices 902 in a given embodiment can include, for example, laptop, tablet or desktop personal computers, mobile telephones, or other types of computers or communication devices, in any combination.

Communications between the various elements of information processing system 900 comprising processing devices 902 associated with respective components of refinery 101 and/or refinery management system 103 may take place over one or more networks, represented in FIG. 9 as network 904. Such networks can illustratively include, for example, a global computer network such as the Internet, a wide area network (WAN), a local area network (LAN), a satellite network, a telephone or cable network, a cellular network, a wireless network implemented using a wireless protocol such as WiFi or WiMAX, or various portions or combinations of these and other types of communication networks.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network as in information processing system 900 of FIG. 9.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

For example, other processing platforms used to implement embodiments of the invention can comprise different types of virtualization infrastructure in place of, or in addition to, virtualization infrastructure comprising virtual machines. Thus, it is possible in some embodiments that system components can run at least in part in cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components or functionality of the system as disclosed herein can be implemented at least in part in the form of one or more software programs stored in memory and executed by a processor of a processing device.

Accordingly, a given component of an information processing system implementing functionality as described herein is illustratively configured utilizing a corresponding processing device comprising a processor coupled to a memory. The processor executes program code stored in the memory in order to control the performance of processing operations and other functionality. The processing device also comprises a network interface that supports communication over one or more networks.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts. The disclosed techniques can be similarly adapted for use in a wide variety of other types of information processing systems.

It is also to be appreciated that the particular process steps used in the embodiments described above are exemplary only, and other embodiments can utilize different types and arrangements of processing operations. For example, certain process steps described as being performed serially in the illustrative embodiments can in other embodiments be performed at least in part in parallel with one another.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. An apparatus, comprising:
at least one processing device comprising a processor coupled to a memory;
the at least one processing device being configured:
to obtain sensor data from one or more sensors associated with one or more coke drums in a refinery implementing a delayed coking process for converting at least a portion of a feedstock to a product stream comprising coke;
to generate an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle; and
to provide, at a user interface, the generated outage projection for the end of the feed cycle of said at least one of the one or more coke drums.

2. The apparatus according to claim 1, wherein the machine learning model comprises a generalized linear model.

3. The apparatus according to claim 1, wherein generating the outage projection for the end of the feed cycle of said at least one of the one or more coke drums is triggered based at least in part on detecting one or more designated conditions during the feed cycle for said at least one of the one or more coke drums.

4. The apparatus according to claim 3, wherein the one or more designated conditions during the feed cycle comprises detecting that the level indicator for said at least one of the one or more coke drums exceeds the designated threshold value.

5. The apparatus according to claim 1, wherein the at least one processing device is further configured to generate, utilizing the machine learning model, a target flowrate for providing the feedstock to said at least one of the one or more coke drums which reaches a designated target outage projection at the end of the feed cycle.

6. The apparatus according to claim 5, wherein generating the target flowrate is responsive to detecting that the outage projection for the end of the feed cycle for said at least one of the one or more coke drums is more than a threshold difference from the designated target outage projection.

7. The apparatus according to claim 5, wherein the at least one processing device is further configured to actuate one or more controls associated with said at least one of the one or more coke drums to automatically adjust a current flowrate of the feedstock to said at least one of the one or more coke drums to the target flowrate.

8. The apparatus according to claim 1, wherein the at least one processing device is further configured to train the machine learning model for said at least one of the one or more coke drums utilizing historical data for a plurality of feed cycles of said at least one of the one or more coke drums.

9. The apparatus according to claim 8, wherein the at least one processing device is further configured to re-train the machine learning model for said at least one of the one or more coke drums in response to detecting that an error in outage projections generated by the machine learning model exceeds a designated threshold in a designated number of most recent feed cycles for said at least one of the one or more coke drums.

10. The apparatus according to claim 1, wherein the generated outage projection is associated with a configurable risk parameter.

11. The apparatus according to claim 10 wherein the configurable risk parameter characterizes a percentage chance that the generated outage projection exceeds a target outage for said at least one of the one or more coke drums.

12. The apparatus according to claim 1, wherein the at least one processing device is further configured to detect, based at least in part on the generated outage projection for the feed cycle, one or more anomalous conditions of said at least one of the one or more coke drums during the feed cycle.

13. The apparatus according to claim 12, wherein the at least one processing device is further configured, responsive to detecting the one or more anomalous conditions, to at least one of:
adjust a feed temperature of the feedstock to said at least one of the one or more coke drums during a remainder of the feed cycle; and
provide an antifoam injection to said at least one of the one or more coke drums.

14. The apparatus according to claim 1, wherein the level indicator for said at least one of the one or more coke drums is determined based at least in part on sensor data from one or more nuclear sensors associated with said at least one of the one or more coke drums.

15. The apparatus of claim 14, wherein the one or more nuclear sensors comprise at least one of: one or more neutron backscatter systems; one or more Gamma-ray sensors; and one or more X-ray sensors.

16. The apparatus according to claim 1, wherein the density of the feedstock fed to said at least one of the one or more coke drums during the feed cycle is determined based at least in part on calculating a running average of American Petroleum Institute (API) gravity of the feedstock fed to said at least one of the one or more coke drums during the feed cycle.

17. A method, comprising:
obtaining sensor data from one or more sensors associated with one or more coke drums in a refinery implementing a delayed coking process for converting at least a portion of a feedstock to a product stream comprising coke;
generating an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle; and
providing, at a user interface, the generated outage projection for the end of the feed cycle of said at least one of the one or more coke drums;
wherein the method is performed by at least one processing device comprising a processor coupled to a memory.

18. The method according to claim 17, further comprising generating, utilizing the machine learning model, a target flowrate for providing the feedstock to said at least one of the one or more coke drums which reaches a designated target outage projection at the end of the feed cycle.

19. A computer program product comprising a non-transitory processor-readable storage medium having stored therein program code of one or more software programs, wherein the program code when executed by at least one processing device causes the at least one processing device:
to obtain sensor data from one or more sensors associated with one or more coke drums in a refinery implementing a delayed coking process for converting at least a portion of a feedstock to a product stream comprising coke;
to generate an outage projection for an end of a feed cycle of at least one of the one or more coke drums by processing, utilizing a machine learning model, information derived from at least a portion of the obtained sensor data characterizing (i) an amount of the feedstock which has been fed to said at least one of the one or more coke drums during the feed cycle, (ii) a time at which a level indicator for said at least one of the one or more coke drums first exceeds a designated threshold value, and (iii) a density of the feedstock fed to said at least one of the one or more coke drums during the feed cycle; and
to provide, at a user interface, the generated outage projection for the end of the feed cycle of said at least one of the one or more coke drums.

20. The computer program product according to claim 19, wherein the program code when executed by the at least one processing device further causes the at least one processing device to generate, utilizing the machine learning model, a target flowrate for providing the feedstock to said at least one of the one or more coke drums which reaches a designated target outage projection at the end of the feed cycle.
